(19) United States
(12) Patent Application Publication
(10) Pub. No.: US 2025/0211326 A1
(43) Pub. Date: Jun. 26, 2025

(54) METHODS, COMMUNICATIONS DEVICES, AND INFRASTRUCTURE EQUIPMENT

(71) Applicant: Sony Group Corporation, Tokyo (JP)

(72) Inventors: Samuel Asangbeng ATUNGSIRI, Basingstoke (GB); Vivek SHARMA, Basingstoke (GB); Yassin Aden AWAD, Basingstoke (GB); Yuxin WEI, Basingstoke (GB)

(73) Assignee: Sony Group Corporation, Tokyo (JP)

(21) Appl. No.: 18/848,171

(22) PCT Filed: Mar. 13, 2023
(86) PCT No.: PCT/EP2023/056387

§ 371 Date: Sep. 18, 2024

(30) Foreign Application Priority Data
Mar. 29, 2022 (EP) 22165234.0

(51) Int. Cl. H04B 7/185; H04W 74/0838; H04W 76/28

(52) U.S. Cl. CPC H04B 7/18545; H04B 7/18532; H04W 74/0838; H04W 76/28

(57) ABSTRACT

A method for operating a communications device in a wireless network formed by non-terrestrial network apparatus and gateways is described. The device operates in an in-coverage mode when within the network's coverage, allowing transmission and reception of signals. When the device is expected to go out of coverage at a specific time, it determines when it will next be in coverage. The device transitions to an out-of-coverage mode when out of range and automatically returns to the in-coverage mode when back within the network's coverage at the determined time.

### BACKGROUND

### Field of Disclosure

The present disclosure relates generally to wireless communications networks, and specifically to methods and devices for handling the transmission of data more efficiently.

The present application claims the Paris Convention priority from European patent application number EP22165234.0, filed on 29 Mar. 2022, the contents of which are hereby incorporated by reference.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Third and fourth generation mobile telecommunication systems, such as those based on the 3GPP defined UMTS and Long Term Evolution (LTE) architecture, are able to support more sophisticated services than simple voice and messaging services offered by previous generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these and future networks, i.e. geographic locations where access to the networks is possible, may be expected to increase ever more rapidly.

Current and future wireless communications networks are expected to routinely and efficiently support communications with a wider range of devices associated with a wider range of data traffic profiles and types than previously developed systems are optimised to support. For example it is expected that future wireless communications networks will be expected to efficiently support communications with devices including reduced complexity devices, machine type communication (MTC) devices, high resolution video displays, virtual reality headsets and so on. Some of these different types of devices may be deployed in very large numbers, for example low complexity devices for supporting the “The Internet of Things”, and may typically be associated with the transmissions of relatively small amounts of data with relatively high latency tolerance.

In view of this there is expected to be a desire for more advanced wireless communications networks, for example those which may be referred to as 5G or new radio (NR) system/new radio access technology (RAT) systems, as well as future iterations/releases of existing systems, to efficiently support connectivity for a wide range of devices associated with different applications and different characteristic data traffic profiles.

One example area of current interest in this regard includes so-called “non-terrestrial networks”, or NTN for short. 3GPP has proposed in Release 15 of the 3GPP specifications to develop technologies for providing coverage by means of one or more antennas mounted on airborne or space-borne vehicles [1].

Non-terrestrial networks may provide service in areas that cannot be covered by terrestrial cellular networks (i.e. those where coverage is provided by means of land-based antennas), such as isolated or remote areas, on board aircraft or ocean-going vessels) or may provide enhanced service in other areas. The expanded coverage that may be achieved by means of non-terrestrial networks may provide service continuity for machine-to-machine (M2M) or ‘internet of things’ (IoT) devices, or for passengers on board moving platforms (e.g. passenger vehicles such as aircraft, ships, high speed trains, or buses). Other benefits may arise from the use of non-terrestrial networks for providing multicast/broadcast resources for data delivery.

The use of different types of network infrastructure equipment and requirements for coverage enhancement give rise to new challenges for efficiently handling communications in wireless communications systems that need to be addressed.

### SUMMARY OF THE DISCLOSURE

The present disclosure can help address or mitigate at least some of the issues discussed above.

Embodiments of the present technique can provide a method of operating a communications device for transmitting signals to and/or receiving signals from a wireless communications network formed by one or more non-terrestrial network apparatus and one or more non-terrestrial network gateways. The method comprises operating in an in-coverage mode of operation with the wireless communications network, wherein in the in-coverage mode of operation the communications device is configured to transmit signals to and/or receive signals from the wireless communications network whilst being within coverage of the wireless communications network, wherein the communications device is within coverage of the wireless communications network when the communications device is located in a coverage area of one of the non-terrestrial network apparatus which is within coverage of one of the non-terrestrial network gateways, determining that the communications device will become out of coverage of the wireless communications network at a first time, determining a second time, later than the first time, at which the communications device will next be in coverage of the wireless communications network, transitioning into an out-of-coverage mode of operation at the first time, and transitioning back into the in-coverage mode of operation with the wireless communications network at the second time.

Embodiments of the present technique, which, in addition to methods for operating communications devices, relate to communications devices, infrastructure equipment, methods for operating such infrastructure equipment, circuitry for such communications devices and infrastructure equipment, wireless communications systems, computer programs, and non-transitory computer-readable storage mediums, allow for the efficient communication of data.

Respective aspects and features of the present disclosure are defined in the appended claims.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 schematically represents some aspects of an LTE-type wireless telecommunication system which may be configured to operate in accordance with certain embodiments of the present disclosure;

FIG. 2 schematically represents some aspects of a new radio access technology (RAT) wireless telecommunications system which may be configured to operate in accordance with certain embodiments of the present disclosure;

FIG. 3 is a schematic block diagram of an example infrastructure equipment and communications device which may be configured to operate in accordance with certain embodiments of the present disclosure;

FIG. 4 is reproduced from [1], and illustrates a first example of a non-terrestrial network (NTN) featuring an access networking service based on a satellite/aerial platform with a bent pipe payload;

FIG. 5 is reproduced from [1], and illustrates a second example of an NTN featuring an access networking service based on a satellite/aerial platform that incorporates a gNodeB;

FIG. 6 schematically shows an example of a wireless communications system comprising an NTN part and a terrestrial network (TN) part which may be configured to operate in accordance with embodiments of the present disclosure;

FIG. 7 is a part schematic, part message flow diagram representation of a wireless communications network comprising a communications device and infrastructure equipment in accordance with embodiments of the present technique; and

FIG. 8 shows a flow diagram illustrating a process of communications in a communications system in accordance with embodiments of the present technique.

### DETAILED DESCRIPTION OF THE EMBODIMENTS

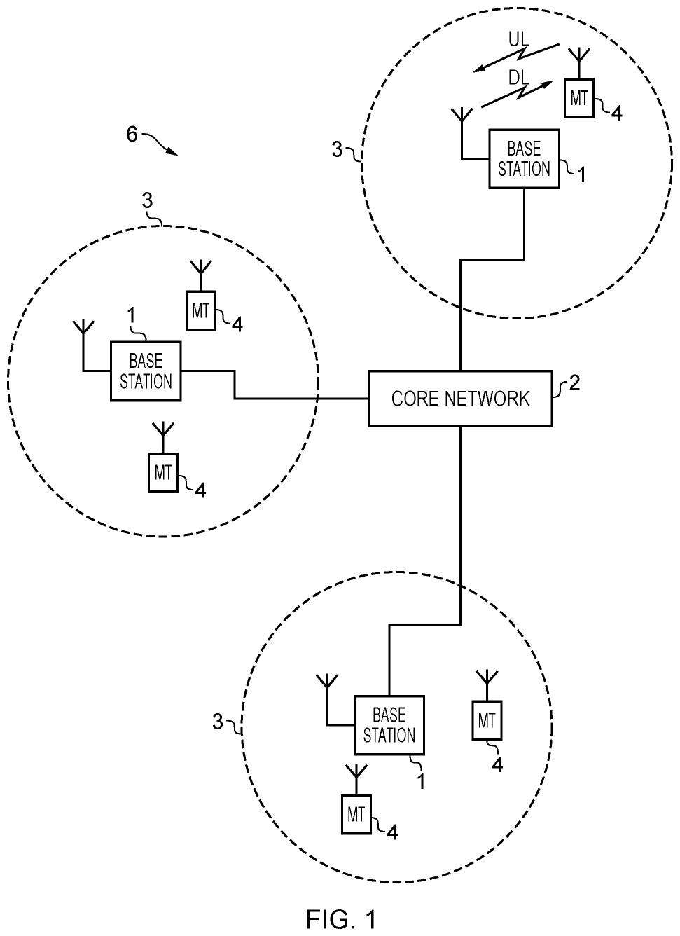

Long Term Evolution Advanced Radio Access Technology (4G) FIG. 1 provides a schematic diagram illustrating some basic functionality of a mobile telecommunications network/system 6 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP (RTM) body, and also described in many books on the subject, for example, Holma H. and Toskala A [2]. It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 6 includes a plurality of base stations 1 connected to a core network 2. Each base station provides a coverage area 3 (i.e. a cell) within which data can be communicated to and from communications devices 4. Although each base station 1 is shown in FIG. 1 as a single entity, the skilled person will appreciate that some of the functions of the base station may be carried out by disparate, inter-connected elements, such as antennas (or antennae), remote radio heads, amplifiers, etc. Collectively, one or more base stations may form a radio access network.

Data is transmitted from base stations 1 to communications devices 4 within their respective coverage areas 3 via a radio downlink (DL). Data is transmitted from communications devices 4 to the base stations 1 via a radio uplink (UL). The core network 2 routes data to and from the communications devices 4 via the respective base stations 1 and provides functions such as authentication, mobility management, charging and so on. Terminal devices may also be referred to as mobile stations, user equipment (UE), user terminal, mobile radio, communications device, and so forth. Services provided by the core network 2 may include connectivity to the internet or to external telephony services. The core network 2 may further track the location of the communications devices 4 so that it can efficiently contact (i.e. page) the communications devices 4 for transmitting downlink data towards the communications devices 4.

Base stations, which are an example of network infrastructure equipment, may also be referred to as transceiver stations, nodeBs, e-nodeBs, eNB, g-nodeBs, gNB and so forth. In this regard different terminology is often associated with different generations of wireless telecommunications systems for elements providing broadly comparable functionality. However, certain embodiments of the disclosure may be equally implemented in different generations of wireless telecommunications systems, and for simplicity certain terminology may be used regardless of the underlying network architecture. That is to say, the use of a specific term in relation to certain example implementations is not intended to indicate these implementations are limited to a certain generation of network that may be most associated with that particular terminology.

### New Radio Access Technology (5G)

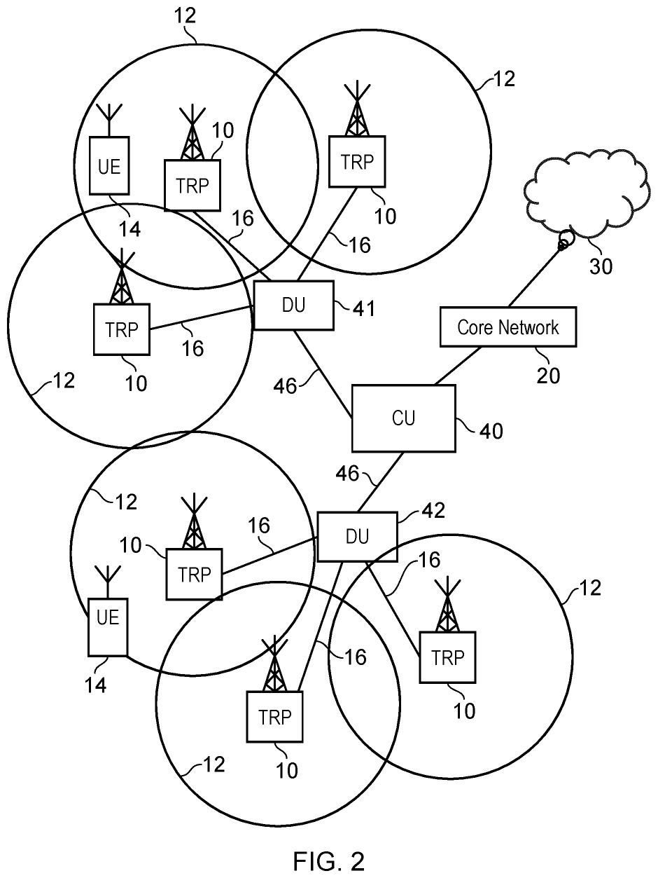

An example configuration of a wireless communications network which uses some of the terminology proposed for and used in NR and 5G is shown in FIG. 2. In FIG. 2 a plurality of transmission and reception points (TRPs) 10 are connected to distributed control units (DUs) 41, 42 by a connection interface represented as a line 16. Each of the TRPs 10 is arranged to transmit and receive signals via a wireless access interface within a radio frequency bandwidth available to the wireless communications network. Thus, within a range for performing radio communications via the wireless access interface, each of the TRPs 10, forms a cell of the wireless communications network as represented by a circle 12. As such, wireless communications devices 14 which are within a radio communications range provided by the cells 12 can transmit and receive signals to and from the TRPs 10 via the wireless access interface. Each of the distributed units 41, 42 are connected to a central unit (CU) 40 (which may be referred to as a controlling node) via an interface 46. The central unit 40 is then connected to the core network 20 which may contain all other functions required to transmit data for communicating to and from the wireless communications devices and the core network 20 may be connected to other networks 30.

The elements of the wireless access network shown in FIG. 2 may operate in a similar way to corresponding elements of an LTE network as described with regard to the example of FIG. 1. It will be appreciated that operational aspects of the telecommunications network represented in FIG. 2, and of other networks discussed herein in accordance with embodiments of the disclosure, which are not specifically described (for example in relation to specific communication protocols and physical channels for communicating between different elements) may be implemented in accordance with any known techniques, for example according to currently used approaches for implementing such operational aspects of wireless telecommunications systems, e.g. in accordance with the relevant standards.

The TRPs 10 of FIG. 2 may in part have a corresponding functionality to a base station or eNodeB of an LTE network. Similarly, the communications devices 14 may have a functionality corresponding to the UE devices 4 known for operation with an LTE network. It will be appreciated therefore that operational aspects of a new RAT network (for example in relation to specific communication protocols and physical channels for communicating between different elements) may be different to those known from LTE or other known mobile telecommunications standards. However, it will also be appreciated that each of the core network component, base stations and communications devices of a new RAT network will be functionally similar to, respectively, the core network component, base stations and communications devices of an LTE wireless communications network.

In terms of broad top-level functionality, the core network 20 connected to the new RAT telecommunications system represented in FIG. 2 may be broadly considered to correspond with the core network 2 represented in FIG. 1, and the respective central units 40 and their associated distributed units/TRPs 10 may be broadly considered to provide functionality corresponding to the base stations 1 of FIG. 1. The term network infrastructure equipment/access node may be used to encompass these elements and more conventional base station type elements of wireless telecommunications systems. Depending on the application at hand the responsibility for scheduling transmissions which are scheduled on the radio interface between the respective distributed units and the communications devices may lie with the controlling node/central unit and/or the distributed units/TRPs. A communications device 14 is represented in FIG. 2 within the coverage area of the first communication cell 12. This communications device 14 may thus exchange signalling with the first central unit 40 in the first communication cell 12 via one of the distributed units/TRPs 10 associated with the first communication cell 12.

It will further be appreciated that FIG. 2 represents merely one example of a proposed architecture for a new RAT based telecommunications system in which approaches in accordance with the principles described herein may be adopted, and the functionality disclosed herein may also be applied in respect of wireless telecommunications systems having different architectures.

Thus, certain embodiments of the disclosure as discussed herein may be implemented in wireless telecommunication systems/networks according to various different architectures, such as the example architectures shown in FIGS. 1 and 2. It will thus be appreciated the specific wireless telecommunications architecture in any given implementation is not of primary significance to the principles described herein. In this regard, certain embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type base station 1 as shown in FIG. 1 which is adapted to provide functionality in accordance with the principles described herein, and in other examples the network infrastructure equipment may comprise a control unit/controlling node 40 and/or a TRP 10 of the kind shown in FIG. 2 which is adapted to provide functionality in accordance with the principles described herein.

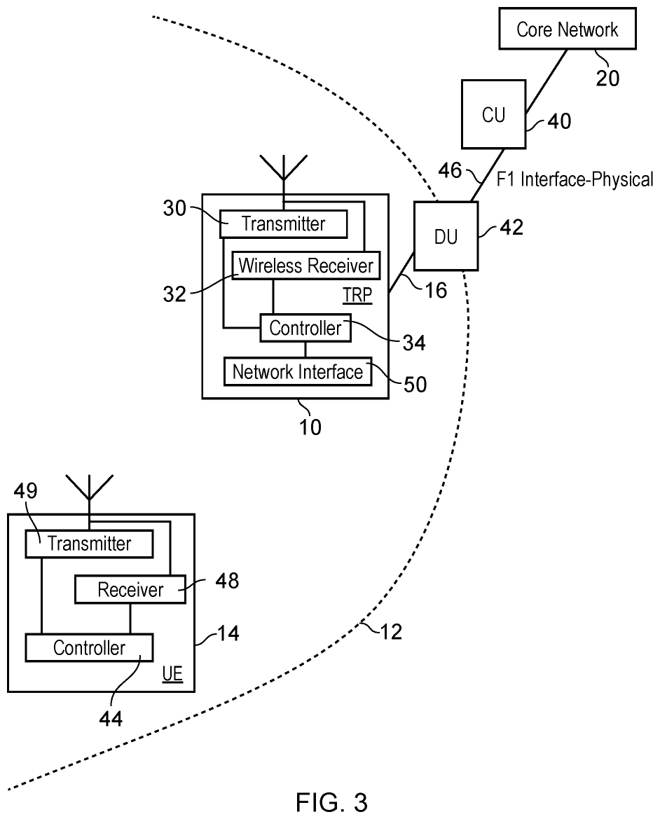

A more detailed diagram of some of the components of the network shown in FIG. 2 is provided by FIG. 3. In FIG. 3, a TRP 10 as shown in FIG. 2 comprises, as a simplified representation, a wireless transmitter 30, a wireless receiver 32 and a controller or controlling processor 34 which may operate to control the transmitter 30 and the wireless receiver 32 to transmit and receive radio signals to one or more UEs 14 within a cell 12 formed by the TRP 10. As shown in FIG. 3, an example UE 14 is shown to include a corresponding transmitter 49, a receiver 48 and a controller 44 which is configured to control the transmitter 49 and the receiver 48 to transmit signals representing uplink data to the wireless communications network via the wireless access interface formed by the TRP 10 and to receive downlink data as signals transmitted by the transmitter 30 and received by the receiver 48 in accordance with the conventional operation.

The transmitters 30, 49 and the receivers 32, 48 (as well as other transmitters, receivers and transceivers described in relation to examples and embodiments of the present disclosure) may include radio frequency filters and amplifiers as well as signal processing components and devices in order to transmit and receive radio signals in accordance for example with the 5G/NR standard. The controllers 34, 44 (as well as other controllers described in relation to examples and embodiments of the present disclosure) may be, for example, a microprocessor, a CPU, or a dedicated chipset, etc., configured to carry out instructions which are stored on a computer readable medium, such as a non-volatile memory. The processing steps described herein may be carried out by, for example, a microprocessor in conjunction with a random access memory, operating according to instructions stored on a computer readable medium. The transmitters, the receivers and the controllers are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment/TRP/base station as well as the UE/communications device will in general comprise various other elements associated with its operating functionality.

As shown in FIG. 3, the TRP 10 also includes a network interface 50 which connects to the DU 42 via a physical interface 16. The network interface 50 therefore provides a communication link for data and signalling traffic from the TRP 10 via the DU 42 and the CU 40 to the core network 20.

The interface 46 between the DU 42 and the CU 40 is known as the F1 interface which can be a physical or a logical interface, and may be formed from a fibre optic or other wired or wireless high bandwidth connection. In one example the connection 16 from the TRP 10 to the DU 42 is via fibre optic. The connection between a TRP 10 and the core network 20 can be generally referred to as a backhaul, which comprises the interface 16 from the network interface 50 of the TRP10 to the DU 42 and the F1 interface 46 from the DU 42 to the CU 40.

### Non-Terrestrial Networks (NTNs)

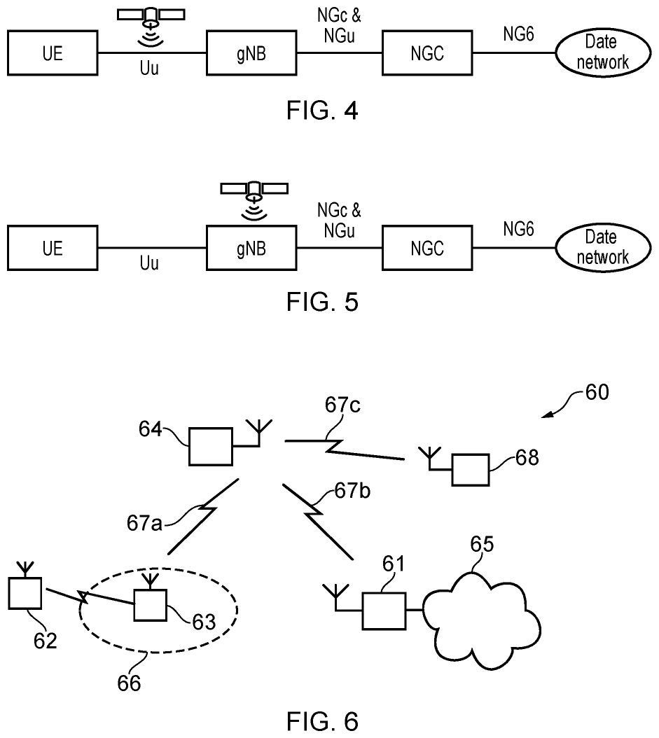

An overview of NR-NTN can be found in [1], and much of the following wording, along with FIGS. 4 and 5, has been reproduced from that document as a way of background.

As a result of the wide service coverage capabilities and reduced vulnerability of space/airborne vehicles to physical attacks and natural disasters, Non-Terrestrial Networks are expected to:
foster the roll out of 5G service in un-served areas that cannot be covered by terrestrial 5G networks (isolated/remote areas, on board aircrafts or vessels) and underserved areas (e.g. sub-urban/rural areas) to upgrade the performance of limited terrestrial networks in a cost effective manner;
reinforce the 5G service reliability by providing service continuity for M2M/IoT devices or for passengers on board moving platforms (e.g. passenger vehicles-aircraft, ships, high speed trains, bus) or ensuring service availability anywhere especially for critical communications, future railway/maritime/aeronautical communications; and to
enable 5G network scalability by providing efficient multicast/broadcast resources for data delivery towards the network edges or even user terminal.

The benefits relate to either Non-Terrestrial Networks operating alone or to integrated terrestrial and Non-Terrestrial networks. They will impact at least coverage, user bandwidth, system capacity, service reliability or service availability, energy consumption and connection density. A role for Non-Terrestrial Network components in the 5G system is expected for at least the following verticals: transport, Public Safety, Media and Entertainment, eHealth, Energy, Agriculture, Finance and Automotive. It should also be noted that the same NTN benefits apply to other technologies such as 4G and/or LTE technologies, and that while NR is sometimes referred to in the present disclosure, the teachings and techniques presented herein are equally applicable to other technologies such as 4G and/or LTE and/or NB-IoT. FIG. 4 illustrates a first example of an NTN architecture based on a satellite/aerial platform with a bent pipe payload, meaning that the signal received from the UE is simply reflected and sent back down to Earth by the satellite/aerial platform, with only frequency or amplification changing; i.e. acting like a pipe with a u-bend. In this example NTN, the satellite or the aerial platform will therefore relay a “satellite friendly” NR (or LTE) signal between the gNodeB (or eNodeB) and UEs in a transparent manner.

FIG. 5 illustrates a second example of an NTN architecture based on a satellite/aerial platform comprising a gNodeB (or eNodeB in the examples of the present disclosure) which may be referred to as non-terrestrial infrastructure equipment. In this example NTN, the satellite or aerial platform carries a full or part of a gNodeB/eNodeB to generate or receive an NR (or LTE) signal to/from the UEs. For example, in addition to frequency conversion and amplification, the satellite/aerial platform may also decode a received signal. This requires the satellite or aerial platform to have sufficient on-board processing capabilities to be able to include a gNodeB or eNodeB functionality.

FIG. 6 schematically shows an example of a wireless communications system 60 which may be configured to operate in accordance with embodiments of the present disclosure. The wireless communications system 60 in this example is based broadly around an LTE-type or 5G-type architecture. Many aspects of the operation of the wireless communications system/network 60 are known and understood and are not described here in detail in the interest of brevity. Operational aspects of the wireless communications system 60 which are not specifically described herein may be implemented in accordance with any known techniques, for example according to the current LTE standards or the current 5G standards.

The wireless communications system 60 comprises a core network part 65 (which may be a 4G core network or a 5G core network) in communicative connection with a radio network part. The radio network part comprises a base station (g-node B) 61 connected to a non-terrestrial network part 64. The non-terrestrial network part 64 may be an example of infrastructure equipment. Alternatively, or in addition, the non-terrestrial network part 64 may be mounted on a satellite vehicle or on an airborne vehicle.

The non-terrestrial network part 64 may communicate with a communications device 63, located within a cell 66, by means of a wireless access interface provided by a wireless communications link 67a. For example, the cell 66 may correspond to the coverage area of a spot beam generated by the non-terrestrial network part 64. The boundary of the cell 66 may depend on an altitude of the non-terrestrial network part 64 and a configuration of one or more antennas of the non-terrestrial network part 64 by which the non-terrestrial network part 64 transmits and receives signals on the wireless access interface.

The non-terrestrial network part 64 may be a satellite in an orbit with respect to the Earth, or may be mounted on such a satellite. For example, the satellite may be in a geo-stationary Earth orbit (GEO) such that the non-terrestrial network part 64 does not move with respect to a fixed point on the Earth's surface.

The geo-stationary Earth orbit may be approximately 36,786 km above the Earth's equator. The satellite may alternatively be in a low-Earth orbit (LEO), in which the non-terrestrial network part 64 may complete an orbit of the Earth relatively quickly, thus providing moving cell coverage. Alternatively, the satellite may be in a non-geostationary orbit (NGSO), so that the non-terrestrial network part 64 moves with respect to a fixed point on the Earth's surface. The non-terrestrial network part 64 may be an airborne vehicle such as an aircraft, or may be mounted on such a vehicle. The airborne vehicle (and hence the non-terrestrial network part 64) may be stationary with respect to the surface of the Earth or may move with respect to the surface of the Earth.

In FIG. 6, the terrestrial station 61 is shown as ground-based, and connected to the non-terrestrial network part 64 by means of a wireless communications (feeder) link 67b. The non-terrestrial network part 64 receives signals representing downlink data transmitted by the base station 61 on the wireless communications link 67b and, based on the received signals, transmits signals representing the downlink data via the wireless communications (service) link 67a providing the wireless access interface for the communications device 63. Similarly, the non-terrestrial network part 64 receives signals representing uplink data transmitted by the communications device 63 via the wireless access interface comprising the wireless communications link 67a and transmits signals representing the uplink data to the terrestrial station 61 on the wireless communications link 67b. The wireless communications links 67a, 67b may operate at a same frequency, or may operate at different frequencies.

The extent to which the non-terrestrial network part 64 processes the received signals may depend upon a processing capability of the non-terrestrial network part 64. For example, the non-terrestrial network part 64 may receive signals representing the downlink data on the wireless communication link 67b, amplify them and (if needed) re-modulate onto an appropriate carrier frequency for onwards transmission on the wireless access interface provided by the wireless communications link 67a. Alternatively, the non-terrestrial network part 64 may be configured to decode the signals representing the downlink data received on the wireless communication link 67b into un-encoded downlink data, re-encode the downlink data and modulate the encoded downlink data onto the appropriate carrier frequency for onwards transmission on the wireless access interface provided by the wireless communications link 67a.

The non-terrestrial network part 64 may be configured to perform some of the functionality conventionally carried out by a base station (e.g. a gNodeB or an eNodeB), such as base station 1 as shown in FIG. 1. In particular, latency-sensitive functionality (such as acknowledging a receipt of the uplink data, or responding to a RACH request) may be performed by the non-terrestrial network part 64 partially implementing some of the functions of a base station.

As mentioned above, a base station may be co-located with the non-terrestrial network part 64; for example, both may be mounted on the same satellite vehicle or airborne vehicle, and there may be a wireless connection providing the coupling between the terrestrial station 61 and the base station co-located on the non-terrestrial network part 64. In such co-located arrangements, a wireless communications feeder link between the terrestrial station 61 and another terrestrial station (not shown) may provide connectivity between the terrestrial station 61 (co-located with the non-terrestrial network part 64) and the core network part 65.

The terrestrial station 61 may be an NTN Gateway that is configured to transmit signals to the non-terrestrial network part 64 via the wireless communications (feeder) link 67b and to communicate with the core network part 65. That is, in some examples the terrestrial station 61 may not include base station functionality. For example, if the base station is co-located with the non-terrestrial network part 64, as described above, the terrestrial station 61 does not implement base station functionality. In other examples, the base station may be co-located with the NTN Gateway in the terrestrial station 61, such that the terrestrial station 61 is capable of performing base station (e.g. gNodeB or eNodeB) functionality.

In some examples, even if the base station is not co-located with the non-terrestrial network part 64 (such that the base station functionality is implemented by a ground-based component), the terrestrial station 61 may not necessarily implement the base station functionality. In other words, the base station (e.g. gNodeB or eNodeB) may not be co-located with the terrestrial station 61 (NTN Gateway). In this manner, the terrestrial station 61 (NTN Gateway) transmits signals received from the non-terrestrial network part 64 to a base station (not shown in FIG. 6). In such an example, the base station (e.g. gNodeB or eNodeB) may be considered as being part of core network part 65, or may be separate (not shown in FIG. 6) from the core network part 65 and located logically between the terrestrial station 61 (NTN Gateway) and the core network part 65.

In some cases, the communications device 63 shown in FIG. 6 may be configured to act as a relay node. That is, it may provide connectivity to one or more terminal devices such as the terminal device 62. When acting as a relay node, the communications device 63 transmits and receives data to and from the terminal device 62, and relays it, via the non-terrestrial network part 64 to the terrestrial station 61. The communications device 63, acting as a relay node, may thus provide connectivity to the core network part 65 for terminal devices which are within a transmission range of the communications device 63.

In some cases, the non-terrestrial network part 64 is also connected to a ground station 68 via a wireless link 67c. The ground station may for example be operated by the satellite operator (which may be the same as the mobile operator for the core and/or radio network or may be a different operator) and the link 67c may be used as a management link and/or to exchange control information. In some cases, once the non-terrestrial network part 64 has identified its current position and velocity, it can send position and velocity information to the ground station 68. The position and velocity information may be shared as appropriate, e.g. with one or more of the UE 63, terrestrial station 61 and base station, for configuring the wireless communication accordingly (e.g. via links 67a and/or 67b). Furthermore, in some cases, the radio network may itself calculate the location of the non-terrestrial network part 64, for example based on ephemeris information of the non-terrestrial network part 64.

It will be apparent to those skilled in the art that many scenarios can be envisaged in which the combination of the communications device 63 and the non-terrestrial network part 64 can provide enhanced service to end users. For example, the communications device 63 may be mounted on a passenger vehicle such as a bus or train which travels through rural areas where coverage by terrestrial base stations may be limited. Terminal devices on the vehicle may obtain service via the communications device 63 acting as a relay, which communicates with the non-terrestrial network part 64.

A challenge of conventional cellular communications techniques may be the relatively high rate at which cell changes occur for the communications device 63 obtaining service from one or more non-terrestrial network parts. For example, where the non-terrestrial network part 64 is mounted on a LEO satellite, the non-terrestrial network part 64 may complete an orbit of the Earth in around 90 minutes; the coverage of a cell generated by the non-terrestrial network part 64 will move very rapidly, with respect to a fixed observation point on the surface of the Earth. Similarly, it may be expected in some cases that the communications device 63 may be mounted on an airborne vehicle itself, having a ground speed of several hundreds of kilometres per hour.

A study has been completed by 3GPP on solutions for NR to support NTN, as detailed in [3]. This study [3] focuses on use cases for satellite access in 5G and service requirements, as well as on evaluating solutions and impacts on RAN protocols and architecture. The study resulted in a new work item [4] that has already been started in RAN working groups to specify the enhancements identified for NR, especially for satellite access via transparent payload LEO and GEO satellites with implicit compatibility to support high altitude platform stations (HAPS) and air to ground (ATG) scenarios.

In addition, 3GPP initiated a new study item [5] for deploying narrowband internet of things (NB-IoT)/enhanced machine type communications (eMTC) over NTN, with the following justifications as detailed in [5]:
IoT operation is critical in remote areas with low/no cellular connectivity for many different industries, including for example:
   Transportation (maritime, road, rail, air) & logistics;
   Solar, oil & gas harvesting;
   Utilities;
   Farming;
   Environment monitoring; and
   Mining etc.; and
From the objectives perspective, at least the following items are addressed in [5]:
   Aspects related to random access procedure/signals [RAN1, RAN2];
   Mechanisms for time/frequency adjustment including Timing Advance, and UL frequency compensation indication [RAN1, RAN2];
   Timing offset related to scheduling and hybrid automatic repeat request acknowledgement (HARQ-ACK) feedback [RAN1, RAN2];
   Aspects related to HARQ operation [RAN2, RAN1];
   General aspects related to timers (e.g. scheduling requests (SR), discontinuous reception (DRX), etc.) [RAN2];
   RAN2 aspects related to idle mode and connected mode mobility [RAN2];
      Radio link failure (RLF)-based for NB-IoT;
      Handover-based for eMTC;
   System information enhancements [RAN2]; and
   Tracking area enhancements [RAN2].

An outline of studies by 3GPP into how to adapt Rel-16 NB-IoT and eMTC for operation over NTN can be found in [6]. The benefits of ubiquitous coverage are key for wide area IoT services.

For the much-vaunted coverage of NTN, an adequately dense constellation of satellites is required to provide ubiquitous coverage of the Earth's surface. The higher the orbit, the fewer the number of satellites that are needed in the constellation to provide ubiquitous coverage of the Earth's surface, as each satellite will be visible to and thus provide coverage to a larger surface area—though clearly more than one satellite will still be required for ubiquitous coverage. Thus, for a given orbital height, there is a minimum number of satellites in any constellation required to provide ubiquitous coverage. If the number of satellites is less than this minimum, then the constellation is said to be sparse, as not everywhere in the service area (which may be the entirety of the Earth's surface or may just be a portion, for example related to national or regional boundaries) is in the coverage of a satellite spot beam at any given time. From the point of view of a given UE at a particular location within the service area, such a UE is said to be in discontinuous coverage, since it is covered by satellite spot beams only intermittently.

Ubiquity of coverage also depends on the density of satellite gateways. This is based on the assessment as to whether a given satellite overflying a particular region of the Earth has an active feeder link to a satellite gateway. If a given satellite does not have such an active feeder link to a satellite gateway, which may be because there is no gateway within the coverage of any of its feeder link spot beams, then UEs located in the region being overflown cannot connect to the network, despite in such a case the UE being in the coverage of at least one satellite spot beam.

There are several problems arising from a lack of ubiquitous coverage in NTN. For example, one such problems may be how UEs in sparse coverage NTN can enjoy certain services, while another may relate to the kinds of services that are possible for such UEs. Such issues have not yet been addressed in the art, though it is expected that there will be further study into enhancements for discontinuous coverage in NTN. Embodiments of the present disclosure provide solutions to such problems, and more generally, provide solutions to the overall problem of how service provision can be organized in a sparse coverage NTN so as to allow UEs in discontinuous coverage to enjoy some services.

### Solutions for NTN Discontinuous Coverage

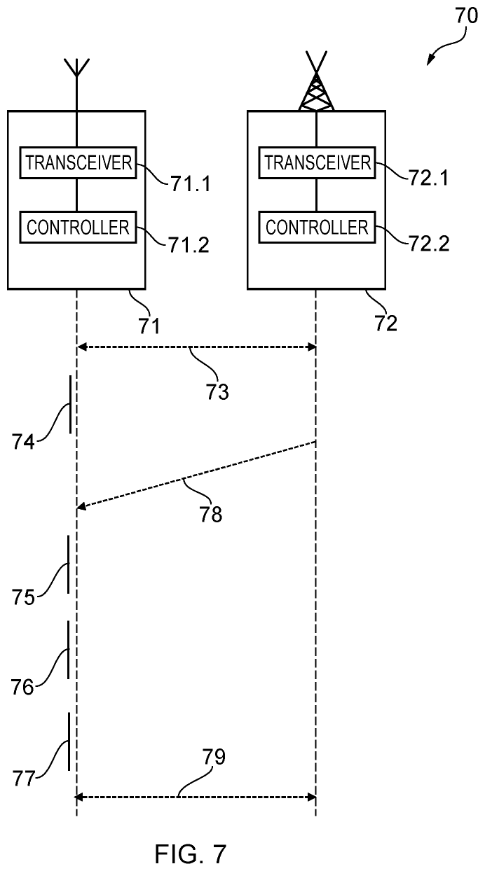

FIG. 7 shows schematic representation of a wireless communications system 70 comprising a communications device 71 and a wireless communications network formed by one or more non-terrestrial network apparatus and one or more non-terrestrial network gateways, the wireless communications system 70 including a first non-terrestrial network apparatus 72 forming part of the wireless communications network. The communications device 71 is configured to transmit signals to and/or to receive signals from the non-terrestrial network apparatus 72. The non-terrestrial network apparatus 72 (which may correspond to non-terrestrial network part 64 of the example wireless communications system of FIG. 6) may be a satellite, an airborne vehicle, an aerial platform, or the like, or may alternatively be mounted upon a satellite, an airborne vehicle, an aerial platform, or the like. Furthermore, the non-terrestrial network apparatus 72 may be an infrastructure equipment (e.g. a gNB or base station) of the wireless communications network—i.e. the non-terrestrial network apparatus 72 may implement functionality of a base station or gNB or the like. Alternatively, such an infrastructure equipment may be mounted upon or otherwise coupled to or carried by the non-terrestrial network apparatus 72. Alternatively, the non-terrestrial network apparatus 72 may relay signals between the communications device 71 and an infrastructure equipment, where such an infrastructure equipment may be a terrestrial (ground-based) infrastructure equipment—here, the non-terrestrial network apparatus 72 may act like a bent pipe as discussed above with respect to FIG. 4, in that the signals are reflected by the non-terrestrial network apparatus 72 between the ground-based infrastructure equipment and the communications device 71 with changed frequency or amplification. The communications device 71 and non-terrestrial network apparatus 72 each comprise a transceiver (or transceiver circuitry) 71.1, 72.1 and a controller (or controller circuitry) 71.2, 72.2. Each of the controllers 71.2, 72.2 may be, for example, a microprocessor, a CPU, or a dedicated chipset, etc. The transceivers (or transceiver circuitry) 71.1, 72.1 of one or both of the communications device 71 and non-terrestrial network apparatus 72 may comprise both a transmitter and a receiver, or may—instead of being a transceiver—be a standalone transmitter and receiver pair. It would be appreciated by those skilled in the art that the non-terrestrial network apparatus 72 (as well as in some arrangements the communications device 71 and any other non-terrestrial network apparatus, infrastructure equipment, or communications devices operating in accordance with embodiments of the present technique) may comprise a plurality of (or at least, one or more) transceivers (or transceiver circuitry) 71.1, 72.1.

Specifically, as is shown by FIG. 7, the transceiver circuitry 71.1 and the controller circuitry 71.2 of the communications device 71 are configured in combination to operate 73 in an in-coverage mode of operation with the wireless communications network, wherein in the in-coverage mode of operation the communications device 71 is configured to transmit signals to and/or receive signals from the wireless communications network (e.g. to and from the non-terrestrial network apparatus 72) whilst being within coverage of the wireless communications network, wherein the communications device 71 is within coverage of the wireless communications network when the communications device 71 is located in a coverage area of one of the non-terrestrial network apparatus (e.g. non-terrestrial network apparatus 72) which is within coverage of one of the non-terrestrial network gateways, to determine 74 that the communications device 71 will become out of coverage of the wireless communications network at a first time (e.g. either where this first time may be a time in the future at which the communications device 71 determines it will become out of coverage, or may be a time at which the communications device 71 makes the determination that it has already become out of coverage—this determination may be made by the communications device 71 itself or may be made by the wireless communications network if the location of the communications device 71 is known to the wireless communications network), to determine 75 a second time (e.g. based on receiving 78 an indication of the first time from the non-terrestrial network apparatus 72 or receiving ephemeris information of one or more of the non-terrestrial network apparatus from the non-terrestrial network apparatus 72 from which the communications device 71 is able to calculate the second time), the second time being later than the first time, at which the communications device 71 will next be in coverage of the wireless communications network, to transition 76 into an out-of-coverage mode of operation at the first time (during which neither the communications device 71 nor the wireless communications network (e.g. the non-terrestrial network apparatus 72) transmit signals to or receive signals from one another), and to transition back 77 into the in-coverage mode of operation with the wireless communications network at the second time. Following transitioning back 77 into the in-coverage mode of operation with the wireless communications network at the second time, the communications device 71 may then be configured to transmit signals 79 to and/or receive signals 79 from the wireless communications network (e.g. to and from the non-terrestrial network apparatus 72) whilst being within coverage of the wireless communications network.

Effectively, at least some embodiments of the present disclosure propose that UE may enter a coverage interrupted state (or mode of operation) upon moving out of coverage of a wireless communications such as an NTN network. This coverage interrupted mode may use hyper-SFN (system frame number) sized timers, and may be configured within the access stratum (AS) layer. Further, during the coverage interrupted mode, the UE and network may freeze or extend all data communication-related timers, and the UE does not occasionally wake up (as it would in accordance with discontinuous reception (DRX) operation) to monitor for physical downlink control channel (PDCCH) transmissions from the network or to carry out any other measurements. The UE wakes up after leaving the coverage interrupted mode (which may be at the expiry of a coverage interrupted timer) and in some arrangements of embodiments of the present disclosure, the network may expect that the UE has woken up and communications will resume after (re-)synchronisation. In other arrangements of embodiments of the present disclosure, the UE provides an indication to let the network know that it has woken up. Such (and other) arrangements of embodiments of the present technique are described in greater detail in the following paragraphs.

While the basic solution provided by embodiments of the present disclosure targets applications such as IoT applications in which UEs have only intermittent data to transmit, embodiments of the present disclosure may also be able to support higher throughput and latency-sensitive services.

In some arrangements of embodiments of the present technique, the satellite may be a transparent mode satellite that has only limited onboard processing capabilities. In other words, the non-terrestrial network apparatus relays communications between the communications device and a ground-based base station.

The applicable techniques are:
While in connected mode, the data is scheduled and held in the originating UE for when coverage is available—coverage of both the originating UE and a gateway for example; and
When coverage is available, data can be transmitted via small data transmission (SDT) (e.g., dynamic or configured grant (CG)) after UL synchronisation as the case may be applicable for UEs in RRC_INACTIVE state.

In other words, the communications device may be configured to determine, while in the out-of-coverage mode of operation, that the communications device has uplink data to transmit to the wireless communications network, to store, while in the out-of-coverage mode of operation, the uplink data in a buffer of the communications device, and to transmit, after transitioning back into the in-coverage mode of operation with the wireless communications network at the second time, the uplink data to the wireless communications network.

In some arrangements of embodiments of the present technique, the satellite is a non-transparent mode satellite with at least DU processing capabilities onboard. In other words, the non-terrestrial network apparatus implements functionality of a base station, or a base station is mounted upon the non-terrestrial network apparatus. The applicable techniques are:
While in connected mode, the data is scheduled and transmitted from the UE to the satellite only when the UE is in a spot beam coverage; and
If the satellite is not in a gateway, the satellite holds the data until when destination gateway coverage is available. Then, after the destination gateway coverage is available, the satellite delivers the data via this gateway. In other words, the infrastructure equipment may be configured to receive uplink data from the communications device while the communications device is in the in-coverage mode of operation with the wireless communications network before the first time, to determine, after receiving the uplink data, that the communications device has become out of coverage of the wireless communications network at the first time due to the first non-terrestrial network apparatus becoming out of coverage of the one of the non-terrestrial network gateways, to store the uplink data at the infrastructure equipment until the first non-terrestrial network apparatus is next in coverage of one of the non-terrestrial network gateways, and subsequently to transmit the uplink data to the one of the non-terrestrial network gateways with which the first non-terrestrial network apparatus is next in coverage of.

The UE does not perform any actions in the AS layer when the UE is out of coverage in this case. This behaviour is similar to Power Saving Mode (PSM), which is already specified for LTE and NR. PSM mode is activated either using AS signalling received by the UE from the radio access network, or NAS signalling received by the UE from the core network, and once PSM mode is activated, the UE then switches off its AS layer. In other words, the out-of-coverage mode of operation is a power saving mode, and wherein the communications device may be configured, while in the power saving mode, to stop all communication with the wireless communications network via the access stratum layer. Here, the communications device may be configured to receive, from the wireless communications network, access stratum, AS, signalling comprising a configuration of the power saving mode.

One drawback of PSM mode is that it may be required to be configured by the core network for an out-of-coverage UE if it has not already been configured by the radio access network. If PSM is to be applied to UEs in discontinuous coverage by the core network then the core network will need to be aware of satellite ephemeris information. Accordingly, this ephemeris information may be provided by the access network (or indeed by the UE). In other words, the infrastructure equipment may be configured to transmit, to a core network, at least one of an indication of ephemeris information of at least one of the non-terrestrial network apparatus and/or an indication that the communications device will become out of coverage at the first time and remain out of coverage until the second time. The core network will also need UE location information for deciding the PSM duration, as satellite orbit is not exactly circular and thus different UEs will be in the coverage of a particular satellite for different durations. Another option here is that the core network is made aware that the UE is in discontinuous coverage through an operator setting; e.g. a PLMN supporting discontinuous coverage and having an out of coverage period of a fixed value. This information is required in the core network, in addition to configuring PSM, for configuring Periodic Tracking Area Update timer values. The core network can relax/suspend/stop the Periodic Tracking Area Update timer, along with other NAS timers (similar to RAN timers), when the UE is out of coverage. In other words, the communications device may be configured to receive, from the core network based on the core network being aware of ephemeris information of at least one of the non-terrestrial network apparatus and/or the core network being aware that the communications device will become out of coverage at the first time and remain out of coverage until the second time, non-access stratum, NAS, signalling comprising a configuration of the power saving mode.

In legacy systems the discontinuous reception (DRX) mechanism allows a UE and the network to cease communicating with each other during an agreed time interval within a defined cycle. A DRX cycle comprises an ON time, during which the UE wakes up and monitors the DL for network transmissions targeted at the UE, and an OFF time during which the network does not initiate any DL transmissions to the UE, thereby allowing the UE to go to sleep. DRX is usually initiated when there is no data to transmit (either in the UL or the DL) and its main purpose is to allow the UE to go to sleep and so save power. One type of DRX is connected mode DRX (CDRX), during cycles of which the UE remains in RRC_CONNECTED mode even during its DRX OFF time. Another type of DRX is idle mode DRX, which can essentially be considered equivalent to idle mode paging.

In some arrangements of embodiments of the present technique, DRX mechanisms can be engaged in discontinuous coverage NTN systems when the UE falls out of coverage. In other words, the communications device becomes out of coverage and in coverage in accordance with a set period, the set period being based on the orbit of the one or more non-terrestrial network apparatus, and the communications device may be configured to operate in accordance with a discontinuous reception, DRX, mode of operation comprising a DRX on period during which the communications device operates in the in-coverage mode of operation and a DRX off period during which the communications device operates in the out-of-coverage mode of operation, wherein operating in accordance with the DRX mode of operation comprises switching between the DRX on period and the DRX off period in accordance with the set period.

The maximum configured duration of a CDRX cycle in the known art is a single SFN cycle, which is about 10 seconds long. This is significantly shorter than would be needed to handle some NTN discontinuous coverage scenarios. In accordance with such arrangements of embodiments of the present technique therefore, it is recognised that the maximum duration of a CDRX cycle needs increasing in order to address the problem of NTN coverage interruption. A further type of DRX is extended DRX (eDRX) (for idle mode DRX) in which the maximum duration of the DRX cycle can be as long as 1024 super frames (also known as a hyper SFN), with a duration of about three hours. This timer duration is long enough for effectively all NTN discontinuous coverage scenarios. In some arrangements of embodiments of the present technique, new timers whose duration is long enough to cover the out of coverage time can also be configured for use in connected mode. In other words, the communications device may be configured to receive, from the wireless communications network, a configuration of a coverage interrupted timer configured to start upon the communications device transitioning into the out-of-coverage mode of operation and to expire at the second time, and transitioning back into the in-coverage mode of operation with the wireless communications network when the coverage interrupted timer expires. The details are explained in the following sections.

In accordance with arrangements of embodiments of the present technique, the UE and network may both be aware of the satellite's movement based on ephemeris information broadcasted in system information. The UE, in RRC_CONNECTED mode, then autonomously moves to a coverage interrupted mode when it is not in the coverage of a satellite. During the coverage interrupted mode, the UE does not perform any of its connected mode actions, such as monitoring of any reference signals, does not allow any timers which are running for data activity/inactivity to expire, and does not perform any measurement reporting or radio link monitoring etc. In other words, the communications device may be configured, while in the out-of-coverage mode of operation, to determine that the communications device should stop performing one or more of: monitoring for reference signals received from the wireless communications network, performing and/or reporting measurements, running of one or more timers configured to expire before the second time, and performing radio link monitoring. This new behaviour is different to normal DRX OFF periods because UE may still perform measurements during DRX OFF periods.

The coverage interrupted mode may be considered to be very similar to PSM mode, except that it is not configured by NAS signalling. The duration of the coverage interrupted timer, which is reset at the point when the UE and network enters the coverage interrupted mode, is configurable either by RRC signalling or system information (SI), and is of the order of a hyper SFN duration. In terms of UE implementation of such a timer, the UE may stop all activities but remain in the RRC state in which it was before it went out of coverage of satellite (i.e. no RRC state change). This way, the UE can save its power and then resume all operations once the satellite comes back (i.e. once the UE is back in NTN coverage).

This UE implementation may be considered to be in understanding with Rel-17 but which presupposes that the UE may only transmit or receive small amounts of data, and that the whole data transfer may be completed during the single visibility of the satellite. The reason for this is that Rel-17 IoT NTN is meant for small amounts of sporadic data transmission/reception only. However, if a UE has a large chunk of data for transmission and/or reception, spanning over more than one period of visibility of the satellite (for example, a video sequence from a security camera that is triggered by detecting movement in its field of view) there is a need to determine a few rules, which are detailed in the paragraphs below.

In some arrangements of embodiments of the present technique, in which the UE is allowed to send its location to the network (i.e. where the communications device is configured to transmit, to the wireless communications network, an indication of a geographic location of the communications device), the network can work out when the UE will enter and leave coverage of each of a certain number of (e.g. four) satellites. These times can be sent to the UE so the appropriate coverage interrupted timer period configuration can be achieved by setting the necessary timers both in the network and the UE accordingly. Just before the UE drops out of coverage, the network or the UE (depending on whether the UE's location can be shared as described above) calculates using the ephemeris information the time for coverage to resume. As described above, the UE may subsequently go to sleep, and when the network assumes the UE's timer has expired, network may in accordance with some arrangements of embodiments of the present technique signal/schedule/page the UE so as to wake it up. In other words, the communications device may be configured to receive, from the wireless communications network after the second time, a paging message indicating that the communications device is to transition back into the in-coverage mode of operation with the wireless communications network. This message can additionally be a Wake Up Signal (WUS), sent either on the same spectrum or a different spectrum (which is used for the purpose of transmitting WUSs only). Since coverage loss is somewhat periodic and predictable (due to being determined by the stable orbits of satellites), the network can learn exactly when the UE's coverage will be disrupted and when it will return. The network can therefore use this information to correct the sleep duration of the UE before the next coverage disruption period and also update its own timers/variables for this UE. In other words, the infrastructure equipment may be configured to determine the set period based on one or more previous times the communications device has become out of coverage and in coverage in accordance with the set period, to determine, based on the determined set period, the second time at which the communications device will next be in coverage of the wireless communications network, and to transmit, to the communications device, an indication of the second time.

The UE may perform no actions during its coverage interrupted mode, and store protocol data units (PDUs) not yet transmitted or PDUs for which acknowledgement/negative acknowledgement (ACK/NACK) signalling is not yet received in its respective HARQ buffers. In other words, the communications device may be configured to determine, while in the out-of-coverage mode of operation, that the communications device has transmitted uplink data to the wireless communications network while in the in-coverage mode of operation for which feedback has not yet been received from the wireless communications network, to store, while in the out-of-coverage mode of operation, the transmitted uplink data in a buffer of the communications device, to receive, after transitioning back into the in-coverage mode of operation with the wireless communications network at the second time, feedback for the transmitted uplink data from the wireless communications network, and to discard the transmitted uplink data from the buffer for which feedback has been received indicating that the transmitted uplink data was successfully received by the wireless communications network.

The connected mode coverage interrupted mode configuration, and that of any additional timers, may be informed to the UE by the network before the coverage disappears. This may result in the simultaneous configuration of coverage interrupted mode and legacy DRX configuration; i.e. a UE may sleep for a period when a satellite is not visible and then apply a normal legacy DRX configuration when satellite is visible and based on traffic characteristics between the UE and that satellite (e.g. long and short sleep). This configuration can also be initiated by the network in the case when coverage interruption is due to satellite loss of gateway coverage, and the UE is still within the coverage area of the satellite itself.

In some arrangements of embodiments of the present technique, data may be stuck in different protocol layers and may therefore need detailed handling. For example, a packet data convergence protocol (PDCP) PDU may become stuck in PDCP/radio link control (RLC) buffer (if the buffer is shared between the PDCP and the RLC layers) at a time at which the coverage disappears. This would mean that the PDU is stored in the transmitting PDCP entity (e.g. at the UE). The receiving PDCP entity (e.g. in the network) may have received a few segments of the overall data transmission but not all of the data. For example, a PDCP PDU may have been segmented to four RLC sequence data units (SDUs), and three of these RLC SDUs may have been successfully received before the coverage disappeared.

In this case, in accordance with embodiments of the present technique, the receiving PDCP entity (which may be in the UE or in the network) shall stop the PDCP discard timer and not let the PDCP or RLC discard timer to expire and then discard the packet. In other words, where the transmitting entity is the communications device, the communications device may be configured to determine, while in the out-of-coverage mode of operation, that the communications device has transmitted only an initial part of uplink data to the wireless communications network while in the in-coverage mode of operation before transitioning into the out-of-coverage mode of operation, to pause, while in the out-of-coverage mode of operation, one or more timers associated with the discarding of the transmitted initial part of the uplink data, to resume, after transitioning back into the in-coverage mode of operation with the wireless communications network at the second time, the one or more timers associated with the discarding of the transmitted initial part of the uplink data, and to transmit, after transitioning back into the in-coverage mode of operation with the wireless communications network at the second time, a remaining part of the uplink data to the wireless communications network. Where the transmitting entity is the wireless communications network, similar and corresponding behaviour should apply. Likewise, similar and corresponding behaviour applies at the receiving entity. For example, where the receiving entity is the communications device, the communications device may be configured to determine, while in the out-of-coverage mode of operation, that the communications device has received only an initial part of downlink data from the wireless communications network while in the in-coverage mode of operation before transitioning into the out-of-coverage mode of operation, to pause, while in the out-of-coverage mode of operation, one or more timers associated with the discarding of the received initial part of the downlink data, to resume, after transitioning back into the in-coverage mode of operation with the wireless communications network at the second time, the one or more timers associated with the discarding of the received initial part of the downlink data, and to receive, after transitioning back into the in-coverage mode of operation with the wireless communications network at the second time, a remaining part of the downlink data from the wireless communications network. Again, where the receiving entity is the wireless communications network, similar and corresponding behaviour should apply.

This action should be based on traffic type because some traffic types are more sensitive to delay (e.g., voice) compared to others (web browsing). So, the network may configure the UE with appropriate action; i.e. dependent on whether a segmented PDU can still be used to construct upper layer PDU or not. In other words, the determination as to whether the PDCP/RLC discard timer should be kept or expired may be based on the traffic type or radio bearer (i.e., the pausing the one or more timers associated with the discarding of the transmitted initial part of the uplink data/the received initial part of the downlink data while in the out-of-coverage mode of operation is based on a traffic type of the uplink/downlink data).

Similar behaviour may be required while dealing with HARQ segments on whether a segment received after coverage resumes can be combined with the previously received segments before coverage was interrupted. For services in which HARQ feedback is enabled, HARQ level management in Layer 1/2 can be handled as described in the following paragraphs.

In accordance with some embodiments of the present disclosure, for dynamic grant (DG) in the downlink or DL semi-persistent scheduling (SPS) where the eNB or gNB has already transmitted the transport block (TB), if the network does not receive a HARQ-ACK response from the UE, the network can schedule a retransmission to the UE. Alternatively, as the network and the UE are desynchronised when coverage is interrupted, a UE can autonomously (re-)transmit the delayed HARQ-ACK response when coverage resumes. In other words, the communications device may be configured to determine, while in the out-of-coverage mode of operation, that the communications device has received downlink data from the wireless communications network while in the in-coverage mode of operation for which the communications device has not yet transmitted feedback to the wireless communications network, to store, while in the out-of-coverage mode of operation, the feedback for the received downlink data in a buffer of the communications device, and to transmit, after transitioning back into the in-coverage mode of operation with the wireless communications network at the second time, the feedback for the received downlink data to the wireless communications network. This means the eNB/gNB transport block processing has to maintain the HARQ buffers for the given HARQ processes during the interval when there is no coverage for the UE. In addition, what is new here is that the HARQ retransmission timers have to be extended or suspended during the duration of interrupted coverage. In other words, the communications device may be configured to pause, while in the out-of-coverage mode of operation, one or more timers associated with the discarding of the feedback for the received downlink data, or to extend, while in the out-of-coverage mode of operation, one or more timers associated with the discarding of the feedback for the received downlink data such that the one or more timers are set to expire at a third time, the third time being later than the second time.

In accordance with some embodiments of the present disclosure, for dynamic grant (DG) in the uplink where the UE has already transmitted the TB, if the UE does not receive a HARQ-ACK response from the network, the network can schedule retransmission from the UE. In other words, the communications device may be configured to determine, while in the out-of-coverage mode of operation, that the communications device has transmitted uplink data to the wireless communications network while in the in-coverage mode of operation for which feedback has not yet been received from the wireless communications network, to store, while in the out-of-coverage mode of operation, the transmitted uplink data in a buffer of the communications device, and to retransmit, after transitioning back into the in-coverage mode of operation with the wireless communications network at the second time, the transmitted uplink data to the wireless communications network. Alternatively, as the network and the UE are desynchronised when coverage is interrupted, the UE can autonomously retransmit the TB on the same resources when coverage resumes. In other words, the transmitted uplink data is retransmitted to the wireless communications network using a same set of uplink resources as the transmitted uplink data was initially transmitted on, the set of uplink resources having been dynamically granted to the communications device by the wireless communications network. In some such arrangements of embodiments of the present technique, these uplink resources may be reserved by the eNB/gNB for the UE for a certain period of time following the UE resynchronising with the network, to ensure that these resources are not allocated to another UE around the time of coverage return for that UE (though the resources can of course be reallocated to other in-coverage UEs that UE is out of coverage). Therefore, a time window following the uplink resynchronisation may be configured by the network for the UE to use the resources it had previously transmitted the uplink data on to retransmit the data. Following the end of this time window, which may or may not be indicated to the UE, these resources can then be re-allocated to other UEs by the eNB/gNB. In other words, the transmitted uplink data may be retransmitted to the wireless communications network within a time window designated by the wireless communications network, the time window indicating a period of time during which the same set of uplink resources as the transmitted uplink data was initially transmitted on will not be reallocated to other communications devices. Should the network successfully receive the retransmitted uplink data before the end of the time window however, the network may in some arrangements be able to re-allocate the resources to other UEs even if the initial period of the time window has not elapsed—the time from which the resources may be re-allocated to other UEs may be the time at which the retransmitted uplink data is successfully received, or may the time at which a HARQ ACK was transmitted by the network or received by the UE.

While again, another aspect that is new here is that the HARQ retransmission timers may have to be extended or suspended during the duration of interrupted coverage. In other words, the communications device may be configured to pause, while in the out-of-coverage mode of operation, one or more timers associated with the discarding of the transmitted uplink data, or to extend, while in the out-of-coverage mode of operation, one or more timers associated with the discarding of the transmitted uplink data such that the one or more timers are set to expire at a third time, the third time being later than the second time.

In accordance with some embodiments of the present disclosure, for configured grant (CG) in the uplink where the UE has already transmitted the TB, and if the configuredGrantTimer has expired, the UE can autonomously retransmit the TB on the earliest opportunity of the CG resource when coverage resumes. In other words, the transmitted uplink data is retransmitted to the wireless communications network using a set of grant-free (i.e. CG) uplink resources. This is new behaviour compared to the legacy CG because in the legacy CG when the configuredGrantTimer expires, the UE assumes the transmission was successful. Another way is to extend or suspend the configuredGrantTimer so that it does not expire until coverage resumes.

When HARQ feedback is disabled for the particular Process ID, then UE should store the new data indicator (NDI) and redundancy version (RV) values of the previous transmission(s). This is needed for handling of transmission time interval (TTI) bundles/repetitions (if configured), whereby the same data is transmitted a few times in different slots and is suitable for applications like voice applications. Voice services may differ in respect of HARQ feedback latencies, and so TTI bundling may be configured. Voice services may not be supported in discontinuous coverage, but TTI bundling may be used by other applications like voice message transfer services. Accordingly, the UE and the network should remember/store the NDI and RV version of previously transmitted data so that the receiver knows what to do with any new transmissions, i.e. whether to combine or not combine or discard previous received data (which may be received prior to the coverage interrupted period).

In accordance with some embodiments of the present disclosure, it is considered that the data should be held at the closest point to the destination—e.g. at the satellite or at the gateway (or indeed at the UE if dealing with uplink data). For example, if the loss of coverage is due to the UE going out of coverage of the satellite, or due to the satellite going out of coverage of the gateway, the UL/DL data will be stored at a different place (i.e. satellite (UL data) or gateway (DL data) if the satellite is out of coverage of the gateway, or at the UE (UL data) or satellite (DL data) if the UE is out of coverage of the satellite). This is to ensure the data is stored at the closest point from where the link to the UE and/or eNB/gNB enters the coverage interrupted mode. Storage at the satellite requires non-transparent satellites. This approach assumes normal operation of upper layers including PHY and, involves the storage of traffic at I/Q streams at the lower PHY layer. This approach still requires upper layer timers to be stopped, or otherwise it would require new handling of introducing new behaviour for timers expiring during the discontinuous coverage. In other words, in terms of operation at the satellite, the infrastructure equipment may be configured to receive uplink data from the communications device while the communications device is in the in-coverage mode of operation with the wireless communications network before the first time, to determine, after receiving the uplink data, that the communications device has become out of coverage of the wireless communications network at the first time due to the first non-terrestrial network apparatus becoming out of coverage of the one of the non-terrestrial network gateways, to store the uplink data at the infrastructure equipment until the first non-terrestrial network apparatus is next in coverage of one of the non-terrestrial network gateways, and subsequently to transmit the uplink data to the one of the non-terrestrial network gateways with which the first non-terrestrial network apparatus is next in coverage of. Alternatively, or in addition, the infrastructure equipment may be configured to determine that the infrastructure equipment has downlink data received via one of the non-terrestrial network gateways, for transmission to the communications device while the communications device is in the in-coverage mode of operation with the wireless communications network before the first time, to determine, after receiving the downlink data for transmission to the communications device, that the communications device has become out of coverage of the wireless communications network at the first time due to the communications device becoming out of coverage of the first non-terrestrial network apparatus, to store the downlink data at the infrastructure equipment until the communications device is next in coverage of one of the non-terrestrial network apparatus, and subsequently to transmit, after determining that the communications device has transitioned back into the in-coverage mode of operation with the wireless communications network at the second time, the downlink data to the communications device.

A satellite will keep on receiving uplink traffic in its orbital path from different UEs in different locations on earth. The eNB/gNB associated with the controlling satellite gateway will handle a large number of active UEs depending on the orbital path of the satellite and may end up supporting a large number of UE contexts compared to a TN gNB/eNB cell and may need extra signalling to fetch the right UE context based on UE location. One solution to this problem anticipated by some arrangements of embodiments of the present technique may be that the UE sends some type of preamble or signature which can identify the UE shortly after coverage resumes, which may then be used by the eNB/gNB to fetch the UE context. In other words, the communications device may be configured to transmit, to the wireless communications network, upon transitioning back into the in-coverage mode of operation with the wireless communications network at the second time, an indication that the communications device has transitioned back into the in-coverage mode of operation, where here this indication may comprise an indication of an identifier associated with the communications device. This identifier may specifically be a contention free random access (CFRA) preamble, which is configured by the network for the UE just before the first time at which the UE becomes out of coverage of the network. The network and UE are then both aware of the CFRA preamble associated with that UE, and the network knows to search for that specific preamble around the second time (e.g. within a predetermined time window covering this second time and a specified duration after the second time) to determine whether or not the UE has moved back into coverage. The network also knows during this time window that it should not configure the same CFRA preamble to another other UE. In other words, the identifier associated with the communications device may be a contention free random access, CFRA, preamble, the CFRA preamble having been indicated to the communications device by the wireless communications network in advance of the first time.

Furthermore, the UE and the network may assume different timing and so each side may as well repeat transmissions a few times unless a confirmation is received (or confirmation sent before indication compensating for RTT). This is of particular importance when the UE does not share its location with the network.

In embodiments in which UE location is either not available or is not allowed to be reported to the network, then the network is unable to calculate when the UE may re-enter coverage. However, from the satellites whose ephemeris information is included in the SI (which may be four satellites), the UE can compute the time to enter and leave coverage by each satellite. In other words, the communications device may be configured to receive, from the wireless communications network, an indication of ephemeris information of at least one of the non-terrestrial network apparatus, and to calculate the second time based on the indicated ephemeris information. The communications device may then further be configured to transmit, to the wireless communications network, an indication of the second time. The time in which the UE does this can be configured by the network as a measurement event. The UE can then report the time of entering and leaving the coverage of each satellite as a measurement result. The UE and network can then use this report to configure behaviour during the coverage interrupted mode by setting up the appropriate timers.

The other option of informing that UE is in the coverage of a satellite or that the satellite is back and providing coverage for the UE is for the UE to provide an indication (e.g. to indicate a one bit indication) in the very first transmission between the UE and the reappeared satellite, as mentioned above. In other words, the communications device may be configured to transmit, to the wireless communications network, upon transitioning back into the in-coverage mode of operation with the wireless communications network at the second time, an indication that the communications device has transitioned back into the in-coverage mode of operation. This indication could be in a HARQ segment, a MAC/RLC/PDCP header, or may be included by the transmitter (either the UE or the network) when trying to re-establish communication with the re-emerged satellite. Alternatively, this indication may be part of the MAC buffer status report (BSR) if it is the first transmission from the UE. In other words, the indication may be comprised within a feedback signal transmitted by the communications device to the wireless communications network in response to downlink data received by the communications device before transitioning into the out-of-coverage mode of operation at the first time, and/or may be comprised within a header of an uplink signal transmitted by the communications device to the wireless communications network, and/or may be comprised within a buffer status report, BSR, indicating a current status of a buffer of the communications device transmitted by the communications device to the wireless communications network.

If UE performs data transfer in RRC INACTIVE state then the behaviour of the UE while entering and leaving the coverage interrupted mode is similar to that of the UE in the RRC_CONNECTED mode. The coverage interrupted mode and the associated timer behaviour are already described above, and hence arrangements of embodiments of the present technique described with respect to a UE in the RRC_CONNECTED mode may equally or similarly apply to a UE in the RRC_INACTIVE mode. If the UE is performing cell selection/reselection, then the behaviour may be considered similar to RRC_IDLE mode. In each case, the UE remains in the RRC state it was in at the point of losing coverage to the point of regaining coverage. In other words, the communications device may be in a connected radio resource control, RRC, state with the wireless communications network upon transitioning into the out-of-coverage mode of operation, and remains in the connected RRC state until after transitioning back into the in-coverage mode of operation, or the communications device may be in an inactive radio resource control, RRC, state with the wireless communications network upon transitioning into the out-of-coverage mode of operation, and remains in the inactive RRC state until after transitioning back into the in-coverage mode of operation, or the communications device may be in an idle radio resource control, RRC, state with the wireless communications network upon transitioning into the out-of-coverage mode of operation, and remains in the idle RRC state until after transitioning back into the in-coverage mode of operation.

If the UE is in IDLE mode when it is out of coverage and when data arrives at the UE, the UE has to work out if it is still in coverage before it starts cell (re-)selection. In Rel-17, the t-Service in the serving cell's system information indicates the time information in relation to when a cell provided via NTN quasi-Earth fixed system is going to stop serving the area it is currently covering. Furthermore, it is agreed that there is no need to provide the timing information about the new upcoming cell for either the Earth fixed scenario or the Earth moving scenario in Rel-17. However, arrangements of embodiments of the present technique propose that the following are addressed:
t-Service should extend to Earth moving cells as well, as when the cell is going to stop serving the area in which the UE is located is predictable in discontinuous coverage systems. In other words, the communications device may be configured to receive, from the wireless communications network, an indication of the second time, the second time having been calculated by the wireless communications network based on ephemeris information of at least one of the non-terrestrial network apparatus. This t-Service extension may therefore be used by UEs in accordance with arrangements of embodiments of the present disclosure. In other words, the communications device may be configured to determine, while in the out-of-coverage mode of operation and the idle RRC state, that the communications device has uplink data to transmit to the wireless communications network, to determine, based on an indication of the second time having been received by the communications device within system information from the wireless communications network, that the communications device is in the out-of-coverage mode of operation at the time of determining that the communications device has the uplink data to transmit to the wireless communications network, and subsequently to store, while in the out-of-coverage mode of operation and the idle RRC state, the uplink data in a buffer of the communications device, to select, after transitioning back into the in-coverage mode of operation with the wireless communications network at the second time, one of the non-terrestrial network apparatus to enter a connected RRC state with, and to transmit, after entering the connected RRC state, the uplink data to the wireless communications network; and
A new timer that indicates when the next available coverage cell is going to provide the service should be included in system information as well. In other words, the system information received from the wireless communications network further may comprise both of an indication of at least one of the non-terrestrial network apparatus that will next provide coverage of the wireless communications network for the communications device and a configuration of a coverage interrupted timer configured to expire at the second time. The indication of the at least one of the non-terrestrial network apparatus that will next provide coverage of the wireless communications network for the communications device may comprise an indication of a series of two or more of the non-terrestrial network apparatus that will provide coverage of the wireless communications network for the communications device in an order according to their orbits (in the overall constellation) of the series of two or more of the non-terrestrial network apparatus. The indicated coverage interrupted timer should be long enough to cover the single satellite scenario. This timer is beneficial for the UE to decide when it needs to start measurements for cell re-selection.

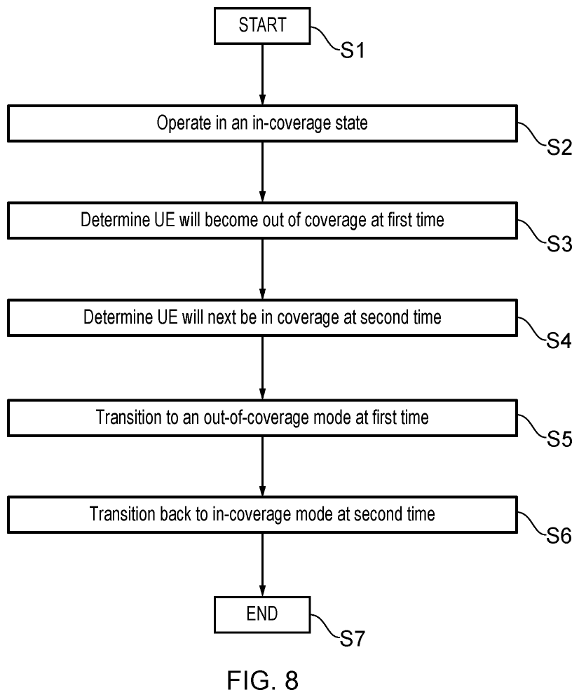

FIG. 8 shows a flow diagram illustrating a first example process of communications in a communications system in accordance with embodiments of the present technique. The process shown by FIG. 8 is a method of operating a communications device for transmitting signals to and/or receiving signals from a wireless communications network formed by one or more non-terrestrial network apparatus and one or more non-terrestrial network gateways.

The method begins in step S1. The method comprises, in step S2, operating in an in-coverage mode of operation with the wireless communications network, wherein in the in-coverage mode of operation the communications device is configured to transmit signals to and/or receive signals from the wireless communications network whilst being within coverage of the wireless communications network, wherein the communications device is within coverage of the wireless communications network when the communications device is located in a coverage area of one of the non-terrestrial network apparatus which is within coverage of one of the non-terrestrial network gateways. In step S3, the process comprises determining that the communications device will become out of coverage of the wireless communications network at a first time. The method then comprises, in step S4, determining a second time, later than the first time, at which the communications device will next be in coverage of the wireless communications network. In step S5, the process comprises transitioning into an out-of-coverage mode of operation at the first time, and in step S6, the method later comprises transitioning back into the in-coverage mode of operation with the wireless communications network at the second time. The process ends in step S7.

Those skilled in the art would appreciate that the method shown by FIG. 8 may be adapted in accordance with embodiments of the present technique. For example, other intermediate steps may be included in the method, or the steps may be performed in any logical order. Furthermore, though embodiments of the present technique have been described largely by way of the example communications system shown in FIG. 7, it would be clear to those skilled in the art that they could be equally applied to other systems to those described herein.

Those skilled in the art would further appreciate that such infrastructure equipment and/or communications devices as herein defined may be further defined in accordance with the various arrangements and embodiments discussed in the preceding paragraphs. It would be further appreciated by those skilled in the art that such infrastructure equipment and communications devices as herein defined and described may form part of communications systems other than those defined by the present disclosure.

The following numbered paragraphs provide further example aspects and features of the present technique:
Paragraph 1. A method of operating a communications device for transmitting signals to and/or receiving signals from a wireless communications network formed by one or more non-terrestrial network apparatus and one or more non-terrestrial network gateways, the method comprising
   operating in an in-coverage mode of operation with the wireless communications network, wherein in the in-coverage mode of operation the communications device is configured to transmit signals to and/or receive signals from the wireless communications network whilst being within coverage of the wireless communications network, wherein the communications device is within coverage of the wireless communications network when the communications device is located in a coverage area of one of the non-terrestrial network apparatus which is within coverage of one of the non-terrestrial network gateways,
   determining that the communications device will become out of coverage of the wireless communications network at a first time,
   determining a second time, later than the first time, at which the communications device will next be in coverage of the wireless communications network,
   transitioning into an out-of-coverage mode of operation at the first time, and
   transitioning back into the in-coverage mode of operation with the wireless communications network at the second time.
Paragraph 2. A method according to Paragraph 1, comprising
   receiving, from the wireless communications network, an indication of ephemeris information of at least one of the non-terrestrial network apparatus, and
   calculating the second time based on the indicated ephemeris information.
Paragraph 3. A method according to Paragraph 2, comprising
   transmitting, to the wireless communications network, an indication of the second time.
Paragraph 4. A method according to any of Paragraphs 1 to 3, comprising
   receiving, from the wireless communications network, an indication of the second time, the second time having been calculated by the wireless communications network based on ephemeris information of at least one of the non-terrestrial network apparatus.
Paragraph 5. A method according to any of Paragraphs 1 to 5, comprising
   receiving, from the wireless communications network, a configuration of a coverage interrupted timer configured to start upon the communications device transitioning into the out-of-coverage mode of operation and to expire at the second time, and
   transitioning back into the in-coverage mode of operation with the wireless communications network when the coverage interrupted timer expires.
Paragraph 6. A method according to any of Paragraphs 1 to 5, wherein the communications device becomes out of coverage and in coverage in accordance with a set period, the set period being based on orbit of the one or more non-terrestrial network apparatus.
Paragraph 7. A method according to Paragraph 6, comprising
   operating in accordance with a discontinuous reception, DRX, mode of operation comprising a DRX on period during which the communications device operates in the in-coverage mode of operation and a DRX off period during which the communications device operates in the out-of-coverage mode of operation,
   wherein operating in accordance with the DRX mode of operation comprises switching between the DRX on period and the DRX off period in accordance with the set period.
Paragraph 8. A method according to any of Paragraphs 1 to 7, wherein the out-of-coverage mode of operation is a power saving mode, and wherein the communications device is configured, while in the power saving mode, to stop all communication with the wireless communications network via the access stratum layer.
Paragraph 9. A method according to Paragraph 8, comprising
   receiving, from a core network based on the core network being aware of ephemeris information of at least one of the non-terrestrial network apparatus and/or the core network being aware that the communications device will become out of coverage at the first time and remain out of coverage until the second time, non-access stratum, NAS, signalling comprising a configuration of the power saving mode.
Paragraph 10. A method according to Paragraph 8 or Paragraph 9, comprising
   receiving, from the wireless communications network, access stratum, AS, signalling comprising a configuration of the power saving mode.
Paragraph 11. A method according to any of Paragraphs 1 to 10, comprising
   transmitting to the wireless communications network, upon transitioning back into the in-coverage mode of operation with the wireless communications network at the second time, an indication that the communications device has transitioned back into the in-coverage mode of operation.
Paragraph 12. A method according to Paragraph 11, wherein the indication that the communications device has transitioned back into the in-coverage mode of operation comprises an indication of an identifier associated with the communications device.
Paragraph 13. A method according to Paragraph 12, wherein the identifier associated with the communications device is a contention free random access, CFRA, preamble, the CFRA preamble having been indicated to the communications device by the wireless communications network in advance of the first time.
Paragraph 14. A method according to any of Paragraphs 11 to 13, wherein the indication is comprised within a feedback signal transmitted by the communications device to the wireless communications network in response to downlink data received by the communications device before transitioning into the out-of-coverage mode of operation at the first time.
Paragraph 15. A method according to any of Paragraphs 11 to 14, wherein the indication is comprised within a header of an uplink signal transmitted by the communications device to the wireless communications network.
Paragraph 16. A method according to any of Paragraphs 11 to 15, wherein the indication is comprised within a buffer status report, BSR, indicating a current status of a buffer of the communications device transmitted by the communications device to the wireless communications network.
Paragraph 17. A method according to any of Paragraphs 1 to 16, comprising
   receiving, from the wireless communications network after the second time, a paging message indicating that the communications device is to transition back into the in-coverage mode of operation with the wireless communications network.
Paragraph 18. A method according to any of Paragraphs 1 to 17, comprising
   determining, while in the out-of-coverage mode of operation, that the communications device has uplink data to transmit to the wireless communications network,
   storing, while in the out-of-coverage mode of operation, the uplink data in a buffer of the communications device, and
   transmitting, after transitioning back into the in-coverage mode of operation with the wireless communications network at the second time, the uplink data to the wireless communications network.
Paragraph 19. A method according to any of Paragraphs 1 to 18, comprising
   determining, while in the out-of-coverage mode of operation, that the communications device has transmitted uplink data to the wireless communications network while in the in-coverage mode of operation for which feedback has not yet been received from the wireless communications network,
   storing, while in the out-of-coverage mode of operation, the transmitted uplink data in a buffer of the communications device,
   receiving, after transitioning back into the in-coverage mode of operation with the wireless communications network at the second time, feedback for the transmitted uplink data from the wireless communications network, and
   discarding the transmitted uplink data from the buffer for which feedback has been received indicating that the transmitted uplink data was successfully received by the wireless communications network.
Paragraph 20. A method according to any of Paragraphs 1 to 19, comprising
   determining, while in the out-of-coverage mode of operation, that the communications device has transmitted only an initial part of uplink data to the wireless communications network while in the in-coverage mode of operation before transitioning into the out-of-coverage mode of operation,
   pausing, while in the out-of-coverage mode of operation, one or more timers associated with the discarding of the transmitted initial part of the uplink data,
   resuming, after transitioning back into the in-coverage mode of operation with the wireless communications network at the second time, the one or more timers associated with the discarding of the transmitted initial part of the uplink data, and
   transmitting, after transitioning back into the in-coverage mode of operation with the wireless communications network at the second time, a remaining part of the uplink data to the wireless communications network.
Paragraph 21. A method according to Paragraph 20, wherein the pausing the one or more timers associated with the discarding of the transmitted initial part of the uplink data while in the out-of-coverage mode of operation is based on a traffic type of the uplink data.
Paragraph 22. A method according to any of Paragraphs 1 to 21, comprising, while in the out-of-coverage mode of operation, determining that the communications device should stop performing one or more of:
   monitoring for reference signals received from the wireless communications network,
   performing and/or reporting measurements,
   running of one or more timers configured to expire before the second time, and
   performing radio link monitoring.
Paragraph 23. A method according to any of Paragraphs 1 to 22, comprising
   transmitting, to the wireless communications network, an indication of a geographic location of the communications device.
Paragraph 24. A method according to any of Paragraphs 1 to 23,
   determining, while in the out-of-coverage mode of operation, that the communications device has received downlink data from the wireless communications network while in the in-coverage mode of operation for which the communications device has not yet transmitted feedback to the wireless communications network,
   storing, while in the out-of-coverage mode of operation, the feedback for the received downlink data in a buffer of the communications device, and
   transmitting, after transitioning back into the in-coverage mode of operation with the wireless communications network at the second time, the feedback for the received downlink data to the wireless communications network.
Paragraph 25. A method according to Paragraph 24, comprising
   pausing, while in the out-of-coverage mode of operation, one or more timers associated with the discarding of the feedback for the received downlink data.
Paragraph 26. A method according to Paragraph 24 or Paragraph 25, comprising
   extending, while in the out-of-coverage mode of operation, one or more timers associated with the discarding of the feedback for the received downlink data such that the one or more timers are set to expire at a third time, the third time being later than the second time.
Paragraph 27. A method according to any of Paragraphs 1 to 26, comprising
   determining, while in the out-of-coverage mode of operation, that the communications device has transmitted uplink data to the wireless communications network while in the in-coverage mode of operation for which feedback has not yet been received from the wireless communications network,
   storing, while in the out-of-coverage mode of operation, the transmitted uplink data in a buffer of the communications device, and
   retransmitting, after transitioning back into the in-coverage mode of operation with the wireless communications network at the second time, the transmitted uplink data to the wireless communications network.
Paragraph 28. A method according to Paragraph 27, comprising
   pausing, while in the out-of-coverage mode of operation, one or more timers associated with the discarding of the transmitted uplink data.
Paragraph 29. A method according to Paragraph 27 or Paragraph 28, comprising
   extending, while in the out-of-coverage mode of operation, one or more timers associated with the discarding of the transmitted uplink data such that the one or more timers are set to expire at a third time, the third time being later than the second time.
Paragraph 30. A method according to any of Paragraphs 27 to 29, wherein the transmitted uplink data is retransmitted to the wireless communications network using a same set of uplink resources as the transmitted uplink data was initially transmitted on, the set of uplink resources having been dynamically granted to the communications device by the wireless communications network.
Paragraph 31. A method according to Paragraph 30, wherein the transmitted uplink data is retransmitted to the wireless communications network within a time window designated by the wireless communications network, the time window indicating a period of time during which the same set of uplink resources as the transmitted uplink data was initially transmitted on will not be reallocated to other communications devices.
Paragraph 32. A method according to any of Paragraphs 27 to 31, wherein the transmitted uplink data is retransmitted to the wireless communications network using a set of grant-free uplink resources.
Paragraph 33. A method according to any of Paragraphs 1 to 32, comprising
   determining, while in the out-of-coverage mode of operation, that the communications device has received only an initial part of downlink data from the wireless communications network while in the in-coverage mode of operation before transitioning into the out-of-coverage mode of operation,
   pausing, while in the out-of-coverage mode of operation, one or more timers associated with the discarding of the received initial part of the uplink data,
   resuming, after transitioning back into the in-coverage mode of operation with the wireless communications network at the second time, the one or more timers associated with the discarding of the received initial part of the uplink data, and
   receiving, after transitioning back into the in-coverage mode of operation with the wireless communications network at the second time, a remaining part of the downlink data from the wireless communications network.
Paragraph 34. A method according to Paragraph 33, wherein the pausing the one or more timers associated with the discarding of the received initial part of the downlink data while in the out-of-coverage mode of operation is based on a traffic type of the downlink data.
Paragraph 35. A method according to any of Paragraphs 1 to 34, wherein the communications device is in a connected radio resource control, RRC, state with the wireless communications network upon transitioning into the out-of-coverage mode of operation, and remains in the connected RRC state until after transitioning back into the in-coverage mode of operation.
Paragraph 36. A method according to any of Paragraphs 1 to 35, wherein the communications device is in an inactive radio resource control, RRC, state with the wireless communications network upon transitioning into the out-of-coverage mode of operation, and remains in the inactive RRC state until after transitioning back into the in-coverage mode of operation.
Paragraph 37. A method according to any of Paragraphs 1 to 36, wherein the communications device is in an idle radio resource control, RRC, state with the wireless communications network upon transitioning into the out-of-coverage mode of operation, and remains in the idle RRC state until after transitioning back into the in-coverage mode of operation.
Paragraph 38. A method according to Paragraph 37, comprising
   determining, while in the out-of-coverage mode of operation and the idle RRC state, that the communications device has uplink data to transmit to the wireless communications network,
   determining, based on an indication of the second time having been received by the communications device within system information from the wireless communications network, that the communications device is in the out-of-coverage mode of operation at the time of determining that the communications device has the uplink data to transmit to the wireless communications network, and subsequently
   storing, while in the out-of-coverage mode of operation and the idle RRC state, the uplink data in a buffer of the communications device,
   selecting, after transitioning back into the in-coverage mode of operation with the wireless communications network at the second time, one of the non-terrestrial network apparatus to enter a connected RRC state with, and
   transmitting, after entering the connected RRC state, the uplink data to the wireless communications network.
Paragraph 39. A method according to Paragraph 38, wherein the system information received from the wireless communications network further comprises both of an indication of at least one of the non-terrestrial network apparatus that will next provide coverage of the wireless communications network for the communications device and a configuration of a coverage interrupted timer configured to expire at the second time.
Paragraph 40. A method according to Paragraph 39, wherein the indication of the at least one of the non-terrestrial network apparatus that will next provide coverage of the wireless communications network for the communications device comprises an indication of a series of two or more of the non-terrestrial network apparatus that will provide coverage of the wireless communications network for the communications device in an order according to the orbits of the series of two or more of the non-terrestrial network apparatus.
Paragraph 41. A method according to any of Paragraphs 1 to 40, wherein the non-terrestrial network apparatus implements functionality of a base station.
Paragraph 42. A method according to any of Paragraphs 1 to 41, wherein a base station is mounted upon the non-terrestrial network apparatus.
Paragraph 43. A method according to any of Paragraphs 1 to 42, wherein the non-terrestrial network apparatus relays communications between the communications device and a ground-based base station.
Paragraph 44. A communications device comprising
   transceiver circuitry configured to transmit signals to and/or to receive signals from a wireless communications network formed by one or more non-terrestrial network apparatus and one or more non-terrestrial network gateways, and
   controller circuitry configured in combination with the transceiver circuitry
   to operate in an in-coverage mode of operation with the wireless communications network, wherein in the in-coverage mode of operation the communications device is configured to transmit signals to and/or receive signals from the wireless communications network whilst being within coverage of the wireless communications network, wherein the communications device is within coverage of the wireless communications network when the communications device is located in a coverage area of one of the non-terrestrial network apparatus which is within coverage of one of the non-terrestrial network gateways,
   to determine that the communications device will become out of coverage of the wireless communications network at a first time,
   to determine a second time, later than the first time, at which the communications device will next be in coverage of the wireless communications network,
   to transition into an out-of-coverage mode of operation at the first time, and
   to transition back into the in-coverage mode of operation with the wireless communications network at the second time.
Paragraph 45. Circuitry for a communications device comprising
   transceiver circuitry configured to transmit signals to and/or to receive signals from a wireless communications network formed by one or more non-terrestrial network apparatus and one or more non-terrestrial network gateways, and
   controller circuitry configured in combination with the transceiver circuitry
   to operate in an in-coverage mode of operation with the wireless communications network, wherein in the in-coverage mode of operation the communications device is configured to transmit signals to and/or receive signals from the wireless communications network whilst being within coverage of the wireless communications network, wherein the communications device is within coverage of the wireless communications network when the communications device is located in a coverage area of one of the non-terrestrial network apparatus which is within coverage of one of the non-terrestrial network gateways,
   to determine that the communications device will become out of coverage of the wireless communications network at a first time,
   to determine a second time, later than the first time, at which the communications device will next be in coverage of the wireless communications network,
   to transition into an out-of-coverage mode of operation at the first time, and
   to transition back into the in-coverage mode of operation with the wireless communications network at the second time.
Paragraph 46. A method of operating an infrastructure equipment forming part of a wireless communications network formed by one or more non-terrestrial network apparatus and one or more non-terrestrial network gateways, the infrastructure equipment being for transmitting signals to and/or receiving signals from a communications device via a first of the non-terrestrial network apparatus, the method comprising
   transmitting signals to and/or receiving signals from the communications device while the communications device is operating in an in-coverage mode of operation with the wireless communications network in which the communications device is within coverage of the wireless communications network when the communications device is located in a coverage area of the first non-terrestrial network apparatus which is within coverage of one of the non-terrestrial network gateways,
   determining that the communications device will become out of coverage of the wireless communications network at a first time,
   determining a second time, later than the first time, at which the communications device will next be in coverage of the wireless communications network,
   determining, at the first time, that the communications device has transitioned into an out-of-coverage mode of operation at the first time, and
   determining, at the second time, that the communications device has transitioned back into the in-coverage mode of operation with the wireless communications network.
Paragraph 47. A method according to Paragraph 46, comprising
   transmitting, to the communications device, an indication of ephemeris information of at least one of the non-terrestrial network apparatus.
Paragraph 48. A method according to Paragraph 47, comprising
   receiving, from the communications device, an indication of the second time, the second time having been calculated by the communications device based on the indicated ephemeris information of the at least one of the non-terrestrial network apparatus.
Paragraph 49. A method according to any of Paragraphs 46 to 48, comprising
   calculating the second time based on ephemeris information of at least one of the non-terrestrial network apparatus, and
   transmitting, to the communications device, an indication of the second time.
Paragraph 50. A method according to any of Paragraphs 46 to 49, comprising
   transmitting, to the communications device, a configuration of a coverage interrupted timer configured to start upon the communications device transitioning into the out-of-coverage mode of operation and to expire at the second time.
Paragraph 51. A method according to any of Paragraphs 46 to 50, comprising
   determining that the communications device becomes out of coverage and in coverage in accordance with a set period, the set period being based on orbit of the one or more non-terrestrial network apparatus.
Paragraph 52. A method according to Paragraph 51, comprising
   determining that the communications device will operate in accordance with a discontinuous reception, DRX, mode of operation comprising a DRX on period during which the communications device operates in the in-coverage mode of operation and a DRX off period during which the communications device operates in the out-of-coverage mode of operation, and
   determining that the communications device, when operating in accordance with the DRX mode of operation, will switch between the DRX on period and the DRX off period in accordance with the set period.
Paragraph 53. A method according to Paragraph 51 or Paragraph 52, comprising
   determining the set period based on one or more previous times the communications device has become out of coverage and in coverage in accordance with the set period,
   determining, based on the determined set period, the second time at which the communications device will next be in coverage of the wireless communications network, and
   transmitting, to the communications device, an indication of the second time.
Paragraph 54. A method according to any of Paragraphs 46 to 53, wherein the out-of-coverage mode of operation is a power saving mode, and wherein the infrastructure equipment is configured, while in the power saving mode, to stop all communication with the communications device via the access stratum layer.
Paragraph 55. A method according to Paragraph 54, comprising
   transmitting, to a core network, an indication of ephemeris information of at least one of the non-terrestrial network apparatus.
Paragraph 56. A method according to Paragraph 55, comprising
   transmitting, to the communications device, access stratum, AS, signalling comprising a configuration of the power saving mode.
Paragraph 57. A method according to any of Paragraphs 46 to 56, comprising
   receiving from the communications device, upon the communications device transitioning back into the in-coverage mode of operation with the wireless communications network at the second time, an indication that the communications device has transitioned back into the in-coverage mode of operation.
Paragraph 58. A method according to Paragraph 57, wherein the indication that the communications device has transitioned back into the in-coverage mode of operation comprises an indication of an identifier associated with the communications device.
Paragraph 59. A method according to Paragraph 58, wherein the identifier associated with the communications device is a contention free random access, CFRA, preamble, the CFRA preamble having been indicated to the communications device by the infrastructure equipment in advance of the first time.
Paragraph 60. A method according to any of Paragraphs 57 to 59, wherein the indication is comprised within a feedback signal received by the infrastructure equipment from the communications device in response to downlink data transmitted by the infrastructure equipment to the communications device before transitioning into the out-of-coverage mode of operation at the first time.
Paragraph 61. A method according to any of Paragraphs 57 to 60, wherein the indication is comprised within a header of an uplink signal received by the infrastructure equipment from the communications device.
Paragraph 62. A method according to any of Paragraphs 57 to 61, wherein the indication is comprised within a buffer status report, BSR, indicating a current status of a buffer of the communications device received by the infrastructure equipment from the communications device.
Paragraph 63. A method according to any of Paragraphs 46 to 62, comprising
   transmitting, to the communications device after the second time, a paging message indicating that the communications device is to transition back into the in-coverage mode of operation with the wireless communications network.
Paragraph 64. A method according to any of Paragraphs 46 to 63, comprising
   receiving, after the communications device has transitioned back into the in-coverage mode of operation with the wireless communications network at the second time, uplink data from the communications device, the uplink data having been stored by the communications device in a buffer of the communications device while the communications device was in the out-of-coverage mode of operation.
Paragraph 65. A method according to any of Paragraphs 46 to 64, comprising, while in the out-of-coverage mode of operation, determining that the communications device will stop performing one or more of:
   monitoring for reference signals transmitted by the infrastructure equipment,
   performing and/or reporting measurements,
   running of one or more timers configured to expire before the second time, and
   performing radio link monitoring.
Paragraph 66. A method according to any of Paragraphs 46 to 65, comprising
   receiving, from the communications device, an indication of a geographic location of the communications device.
Paragraph 67. A method according to any of Paragraphs 46 to 66,
   transmitting downlink data to the communications device while the communications device is in the in-coverage mode of operation with the wireless communications network before the first time, and
   receiving, after the communications device has transitioned back into the in-coverage mode of operation with the wireless communications network at the second time, feedback for the received downlink data from the communications device, the feedback having been stored by the communications device in a buffer of the communications device while the communications device was in the out-of-coverage mode of operation.
Paragraph 68. A method according to any of Paragraphs 46 to 67, comprising
   receiving uplink data from the communications device while the communications device is in the in-coverage mode of operation with the wireless communications network before the first time, and
   receiving, after the communications device has transitioned back into the in-coverage mode of operation with the wireless communications network at the second time, a retransmission of the transmitted uplink data from the communications device.
Paragraph 69. A method according to Paragraph 68, wherein the retransmission is received by the infrastructure equipment within a same set of uplink resources within which the transmitted uplink data was initially received, the set of uplink resources having been dynamically granted to the communications device by the infrastructure equipment.
Paragraph 70. A method according to Paragraph 69, wherein the retransmission is received by the infrastructure equipment within a time window designated by the infrastructure equipment, the time window indicating a period of time during which the same set of uplink resources as the transmitted uplink data was initially received on will not be reallocated to other communications devices.
Paragraph 71. A method according to any of Paragraphs 68 to 70, wherein the retransmission is received by the infrastructure equipment within a set of grant-free uplink resources.
Paragraph 72. A method according to any of Paragraphs 46 to 71, comprising
   receiving uplink data from the communications device while the communications device is in the in-coverage mode of operation with the wireless communications network before the first time,
   determining, after receiving the uplink data, that the communications device has become out of coverage of the wireless communications network at the first time due to the first non-terrestrial network apparatus becoming out of coverage of the one of the non-terrestrial network gateways,
   storing the uplink data at the infrastructure equipment until the first non-terrestrial network apparatus is next in coverage of one of the non-terrestrial network gateways, and subsequently
   transmitting the uplink data to the one of the non-terrestrial network gateways with which the first non-terrestrial network apparatus is next in coverage of.
Paragraph 73. A method according to any of Paragraphs 46 to 72, comprising
   determining that the infrastructure equipment has downlink data received via one of the non-terrestrial network gateways, for transmission to the communications device while the communications device is in the in-coverage mode of operation with the wireless communications network before the first time,
   determining, after receiving the downlink data for transmission to the communications device, that the communications device has become out of coverage of the wireless communications network at the first time due to the communications device becoming out of coverage of the first non-terrestrial network apparatus,
   storing the downlink data at the infrastructure equipment until the communications device is next in coverage of one of the non-terrestrial network apparatus, and subsequently
   transmitting, after determining that the communications device has transitioned back into the in-coverage mode of operation with the wireless communications network at the second time, the downlink data to the communications device.
Paragraph 74. A method according to any of Paragraphs 46 to 73, comprising
   determining, while in the out-of-coverage mode of operation, that the infrastructure equipment has transmitted only an initial part of downlink data to the communications device while the communications device was in the in-coverage mode of operation before transitioning into the out-of-coverage mode of operation,
   pausing, while the communications device is in the out-of-coverage mode of operation, one or more timers associated with the discarding of the transmitted initial part of the downlink data,
   resuming, after determining that the communications device has transitioned back into the in-coverage mode of operation with the wireless communications network at the second time, the one or more timers associated with the discarding of the transmitted initial part of the downlink data, and
   transmitting, after determining that the communications device has transitioned back into the in-coverage mode of operation with the wireless communications network at the second time, a remaining part of the downlink data to the communications device.
Paragraph 75. A method according to Paragraph 74, wherein the pausing the one or more timers associated with the discarding of the transmitted initial part of the downlink data while the communications device is in the out-of-coverage mode of operation is based on a traffic type of the downlink data.
Paragraph 76. A method according to any of Paragraphs 46 to 75, comprising
   determining, while in the out-of-coverage mode of operation, that the infrastructure equipment has received only an initial part of uplink data from the communications device while the communications device was in the in-coverage mode of operation before transitioning into the out-of-coverage mode of operation,
   pausing, while the communications device is in the out-of-coverage mode of operation, one or more timers associated with the discarding of the received initial part of the uplink data,
   resuming, after determining that the communications device has transitioned back into the in-coverage mode of operation with the wireless communications network at the second time, the one or more timers associated with the discarding of the received initial part of the uplink data, and
   receiving, after determining that the communications device has transitioned back into the in-coverage mode of operation with the wireless communications network at the second time, a remaining part of the uplink data from the wireless communications network.
Paragraph 77. A method according to Paragraph 76, wherein the pausing the one or more timers associated with the discarding of the received initial part of the uplink data while the communications device is in the out-of-coverage mode of operation is based on a traffic type of the uplink data.
Paragraph 78. A method according to any of Paragraphs 46 to 77, comprising
   determining that the communications device is in a connected radio resource control, RRC, state with the wireless communications network upon transitioning into the out-of-coverage mode of operation, and
   determining that the communications device remains in the connected RRC state until after transitioning back into the in-coverage mode of operation.
Paragraph 79. A method according to any of Paragraphs 46 to 78, comprising
   determining that the communications device is in an inactive radio resource control, RRC, state with the wireless communications network upon transitioning into the out-of-coverage mode of operation, and
   determining that the communications device remains in the inactive RRC state until after transitioning back into the in-coverage mode of operation.
Paragraph 80. A method according to any of Paragraphs 46 to 79, comprising
   determining that the communications device is in an idle radio resource control, RRC, state with the wireless communications network upon transitioning into the out-of-coverage mode of operation, and
   determining that the communications device remains in the idle RRC state until after transitioning back into the in-coverage mode of operation.
Paragraph 81. A method according to Paragraph 80, comprising
   transmitting, to the communications device, system information comprising an indication of the second time,
   performing a reselection process with the communications device after the communications device has transitioned back into the in-coverage mode of operation with the wireless communications network at the second time, and
   receiving, after the performing of the reselection process, uplink data from the communications device, the uplink data having been stored by the communications device in a buffer of the communications device while the communications device was in the out-of-coverage mode of operation.
Paragraph 82. A method according to Paragraph 81, wherein the system information transmitted to the communications device further comprises both of an indication of one of the non-terrestrial network apparatus that will next provide coverage of the wireless communications network for the communications device and a configuration of a coverage interrupted timer configured to expire at the second time.
Paragraph 83. A method according to Paragraph 82, wherein the indication of the at least one of the non-terrestrial network apparatus that will next provide coverage of the wireless communications network for the communications device comprises an indication of a series of two or more of the non-terrestrial network apparatus that will provide coverage of the wireless communications network for the communications device in an order according to the orbits of the series of two or more of the non-terrestrial network apparatus.
Paragraph 84. A method according to any of Paragraphs 46 to 83, wherein the infrastructure equipment is implemented within the non-terrestrial network apparatus.
Paragraph 85. A method according to any of Paragraphs 46 to 84, wherein the infrastructure equipment is mounted upon the non-terrestrial network apparatus.
Paragraph 86. A method according to any of Paragraphs 46 to 85, wherein the infrastructure equipment is a ground-based base station, and wherein the non-terrestrial network apparatus relays communications between the communications device and the infrastructure equipment.
Paragraph 87. An infrastructure equipment forming part of a wireless communications network formed by one or more non-terrestrial network apparatus and one or more non-terrestrial network gateways, the infrastructure equipment comprising
   transceiver circuitry configured to transmit signals to and/or to receive signals from a communications device via a first of the non-terrestrial network apparatus, and
   controller circuitry configured in combination with the transceiver circuitry
   to transmit signals to and/or to receive signals from the communications device while the communications device is operating in an in-coverage mode of operation with the wireless communications network in which the communications device is within coverage of the wireless communications network when the communications device is located in a coverage area of the first non-terrestrial network apparatus which is within coverage of one of the non-terrestrial network gateways,
   to determine that the communications device will become out of coverage of the wireless communications network at a first time,
   to determine a second time, later than the first time, at which the communications device will next be in coverage of the wireless communications network,
   to determine, at the first time, that the communications device has transitioned into an out-of-coverage mode of operation at the first time, and
   to determine, at the second time, that the communications device has transitioned back into the in-coverage mode of operation with the wireless communications network.
Paragraph 88. Circuitry for an infrastructure equipment forming part of a wireless communications network formed by one or more non-terrestrial network apparatus and one or more non-terrestrial network gateways, the infrastructure equipment comprising
   transceiver circuitry configured to transmit signals to and/or to receive signals from a communications device via a first of the non-terrestrial network apparatus, and
   controller circuitry configured in combination with the transceiver circuitry
   to transmit signals to and/or to receive signals from the communications device while the communications device is operating in an in-coverage mode of operation with the wireless communications network in which the communications device is within coverage of the wireless communications network when the communications device is located in a coverage area of the first non-terrestrial network apparatus which is within coverage of one of the non-terrestrial network gateways,
   to determine that the communications device will become out of coverage of the wireless communications network at a first time,
   to determine a second time, later than the first time, at which the communications device will next be in coverage of the wireless communications network,
   to determine, at the first time, that the communications device has transitioned into an out-of-coverage mode of operation at the first time, and
   to determine, at the second time, that the communications device has transitioned back into the in-coverage mode of operation with the wireless communications network.
Paragraph 89. A wireless communications system comprising a communications device according to Paragraph 44 and an infrastructure equipment according to Paragraph 87.
Paragraph 90. A computer program comprising instructions which, when loaded onto a computer, cause the computer to perform a method according to any of Paragraphs 1 to 43 or any of Paragraphs 46 to 86.
Paragraph 91. A non-transitory computer-readable storage medium storing a computer program according to Paragraph 90.

In so far as embodiments of the disclosure have been described as being implemented, at least in part, by software-controlled data processing apparatus, it will be appreciated that a non-transitory machine-readable medium carrying such software, such as an optical disk, a magnetic disk, semiconductor memory or the like, is also considered to represent an embodiment of the present disclosure.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed, the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognise that various features of the described embodiments may be combined in any manner suitable to implement the technique.

### REFERENCES

[1] TR 38.811 V15.4.0, “Study on New Radio (NR) to support non terrestrial networks (Release 15)”, 3rd Generation Partnership Project, October 2020.
[2] Holma H. and Toskala A, “LTE for UMTS OFDMA and SC-FDMA based radio access”, John Wiley and Sons, 2009.
[3] TR 38.821 V16.0.0, “Solutions for NR to support Non-Terrestrial Networks (NTN)” 3rd Generation Partnership Project, January 2020.
[4] RP-202908, “Solutions for NR to support non-terrestrial networks (NTN)”, Thales, RANP #90e, December 2020.
[5] RP-193235, “New Study WID on NB-IoT/eMTC support for NTN”, MediaTek Inc. RANP #86, December 2019.
[6] TR 36.763, “Study on Narrow-Band Internet of Things (NB-IoT)/enhanced Machine Type Communication (eMTC) support for Non-Terrestrial Networks (NTN) (Release 17)”, 3^{rd} Generation Partnership Project, June 2021.

1. A method of operating a communications device for transmitting signals to and/or receiving signals from a wireless communications network formed by one or more non-terrestrial network apparatus and one or more non-terrestrial network gateways, the method comprising
operating in an in-coverage mode of operation with the wireless communications network, wherein in the in-coverage mode of operation the communications device is configured to transmit signals to and/or receive signals from the wireless communications network whilst being within coverage of the wireless communications network, wherein the communications device is within coverage of the wireless communications network when the communications device is located in a coverage area of one of the non-terrestrial network apparatus which is within coverage of one of the non-terrestrial network gateways,
determining that the communications device will become out of coverage of the wireless communications network at a first time,
determining a second time, later than the first time, at which the communications device will next be in coverage of the wireless communications network,
transitioning into an out-of-coverage mode of operation at the first time, and
transitioning back into the in-coverage mode of operation with the wireless communications network at the second time.

2. A method according to claim 1, comprising
receiving, from the wireless communications network, an indication of ephemeris information of at least one of the non-terrestrial network apparatus, and
calculating the second time based on the indicated ephemeris information.

3. A method according to claim 2, comprising
transmitting, to the wireless communications network, an indication of the second time.

4. A method according to claim 1, comprising
receiving, from the wireless communications network, an indication of the second time, the second time having been calculated by the wireless communications network based on ephemeris information of at least one of the non-terrestrial network apparatus.

5. A method according to claim 1, comprising
receiving, from the wireless communications network, a configuration of a coverage interrupted timer configured to start upon the communications device transitioning into the out-of-coverage mode of operation and to expire at the second time, and
transitioning back into the in-coverage mode of operation with the wireless communications network when the coverage interrupted timer expires.

6. A method according to claim 1, wherein the communications device becomes out of coverage and in coverage in accordance with a set period, the set period being based on orbit of the one or more non-terrestrial network apparatus.

7. A method according to claim 6, comprising
operating in accordance with a discontinuous reception, DRX, mode of operation comprising a DRX on period during which the communications device operates in the in-coverage mode of operation and a DRX off period during which the communications device operates in the out-of-coverage mode of operation,
wherein operating in accordance with the DRX mode of operation comprises switching between the DRX on period and the DRX off period in accordance with the set period.

8. A method according to claim 1, wherein the out-of-coverage mode of operation is a power saving mode, and wherein the communications device is configured, while in the power saving mode, to stop all communication with the wireless communications network via the access stratum layer.

9. A method according to claim 8, comprising
receiving, from a core network based on the core network being aware of ephemeris information of at least one of the non-terrestrial network apparatus and/or the core network being aware that the communications device will become out of coverage at the first time and remain out of coverage until the second time, non-access stratum, NAS, signalling comprising a configuration of the power saving mode.

10. A method according to claim 8, comprising
receiving, from the wireless communications network, access stratum, AS, signalling comprising a configuration of the power saving mode.

11. A method according to claim 1, comprising
transmitting to the wireless communications network, upon transitioning back into the in-coverage mode of operation with the wireless communications network at the second time, an indication that the communications device has transitioned back into the in-coverage mode of operation.

12. A method according to claim 11, wherein the indication that the communications device has transitioned back into the in-coverage mode of operation comprises an indication of an identifier associated with the communications device.

13. A method according to claim 12, wherein the identifier associated with the communications device is a contention free random access, CFRA, preamble, the CFRA preamble having been indicated to the communications device by the wireless communications network in advance of the first time.

14. A method according to claim 11, wherein the indication is comprised within a feedback signal transmitted by the communications device to the wireless communications network in response to downlink data received by the communications device before transitioning into the out-of-coverage mode of operation at the first time.

15. A method according to claim 11, wherein the indication is comprised within a header of an uplink signal transmitted by the communications device to the wireless communications network.

16. A method according to claim 11, wherein the indication is comprised within a buffer status report, BSR, indicating a current status of a buffer of the communications device transmitted by the communications device to the wireless communications network.

17. A method according to claim 1, comprising
receiving, from the wireless communications network after the second time, a paging message indicating that the communications device is to transition back into the in-coverage mode of operation with the wireless communications network.

18. A method according to claim 1, comprising
determining, while in the out-of-coverage mode of operation, that the communications device has uplink data to transmit to the wireless communications network,
storing, while in the out-of-coverage mode of operation, the uplink data in a buffer of the communications device, and
transmitting, after transitioning back into the in-coverage mode of operation with the wireless communications network at the second time, the uplink data to the wireless communications network.

19.-43. (canceled)

44. A communications device comprising
transceiver circuitry configured to transmit signals to and/or to receive signals from a wireless communications network formed by one or more non-terrestrial network apparatus and one or more non-terrestrial network gateways, and
controller circuitry configured in combination with the transceiver circuitry
to operate in an in-coverage mode of operation with the wireless communications network, wherein in the in-coverage mode of operation the communications device is configured to transmit signals to and/or receive signals from the wireless communications network whilst being within coverage of the wireless communications network, wherein the communications device is within coverage of the wireless communications network when the communications device is located in a coverage area of one of the non-terrestrial network apparatus which is within coverage of one of the non-terrestrial network gateways,
to determine that the communications device will become out of coverage of the wireless communications network at a first time,
to determine a second time, later than the first time, at which the communications device will next be in coverage of the wireless communications network,
to transition into an out-of-coverage mode of operation at the first time, and
to transition back into the in-coverage mode of operation with the wireless communications network at the second time.

45.-86. (canceled)

87. An infrastructure equipment forming part of a wireless communications network formed by one or more non-terrestrial network apparatus and one or more non-terrestrial network gateways, the infrastructure equipment comprising
transceiver circuitry configured to transmit signals to and/or to receive signals from a communications device via a first of the non-terrestrial network apparatus, and
controller circuitry configured in combination with the transceiver circuitry
to transmit signals to and/or to receive signals from the communications device while the communications device is operating in an in-coverage mode of operation with the wireless communications network in which the communications device is within coverage of the wireless communications network when the communications device is located in a coverage area of the first non-terrestrial network apparatus which is within coverage of one of the non-terrestrial network gateways,
to determine that the communications device will become out of coverage of the wireless communications network at a first time,
to determine a second time, later than the first time, at which the communications device will next be in coverage of the wireless communications network,
to determine, at the first time, that the communications device has transitioned into an out-of-coverage mode of operation at the first time, and
to determine, at the second time, that the communications device has transitioned back into the in-coverage mode of operation with the wireless communications network.

88.-91. (canceled)
